(19) United States
(12) Patent Application Publication
(10) Pub. No.: US 2025/0355225 A1
(43) Pub. Date: Nov. 20, 2025

(54) OPTICAL SYSTEM AND CAMERA MODULE COMPRISING SAME

(71) Applicant: LG INNOTEK CO., LTD., Seoul (KR)

(72) Inventor: Doo Shik SIN, Seoul (KR)

(21) Appl. No.: 18/870,551

(22) PCT Filed: Jun. 7, 2023
(86) PCT No.: PCT/KR2023/007785

§ 371 Date: Nov. 29, 2024

(30) Foreign Application Priority Data
Jun. 7, 2022 (KR) 10-2022-0068940

(51) Int. Cl. G02B 9/64; G02B 13/06

(52) U.S. Cl. CPC G02B 9/64; G02B 13/06

(57) ABSTRACT

An optical system disclosed in the embodiment of the invention comprises first to eleventh lenses arranged along the optical axis toward a sensor side from an object side, wherein the first lens has positive refractive power on the optical axis and has a meniscus shape convex toward the object side, the eleventh lens has a negative refractive power on the optical axis and has a concave sensor-side surface, the sensor-side surface of the eleventh lens has a critical point between the optical axis and an end of an effective region, object-side and sensor-side surfaces of the tenth lens are provided without a critical point from the optical axis to an end of an effective region, and object-side and sensor-side surfaces of the tenth lens may have an inclination angle of 10 degrees or less from the optical axis to 43% or more of an effective radius of the tenth lens.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions.

For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for the camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

However, when a plurality of lenses is included, there is a problem in that it is difficult to derive excellent optical properties and aberration properties. In addition, when a plurality of lenses is included, the overall length, height, etc. may increase due to the thickness, distance, size, etc. of the plurality of lenses, thereby increasing the overall size of the module including the plurality of lenses.

In addition, the size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system.

Therefore, a new optical system capable of solving the above problems is required.

### DISCLOSURE

### Technical Problem

An embodiment of the invention provides an optical system with improved optical properties.

The embodiment provides an optical system having excellent optical performance at the center and periphery portions of the field of view.

The embodiment provides an optical system capable of having a slim structure.

### Technical Solution

An optical system according to an embodiment of the invention comprises first to eleventh lenses arranged along an optical axis toward a sensor side from an object side, wherein the first lens has positive refractive power on the optical axis and has a meniscus shape convex toward the object side, the eleventh lens has a negative refractive power on the optical axis and has a concave sensor-side surface, the sensor-side surface of the eleventh lens has a critical point between the optical axis and an end of an effective region, an object-side surface and a sensor-side surface of the tenth lens are provided without a critical point from the optical axis to an end of an effective region, and an object-side surface and a sensor-side surface of the tenth lens may have an inclination angle of 10 degrees or less from the optical axis to 43% or more of an effective radius of the tenth lens.

According to an embodiment of the invention, the sensor-side surface of the eleventh lens may have an inclination angle of 10 degrees or less from the optical axis to 45% or more of an effective radius.

According to an embodiment of the invention, object-side and sensor-side surfaces of the seventh to ninth lenses may have an inclination angle of less than 10 degrees from the optical axis to more than 45% of an effective radius of the object-side surface of the seventh lens.

According to an embodiment of the invention, the second lens may have a meniscus shape convex toward the object side, and the eleventh lens may have a meniscus shape convex toward the object side.

According to an embodiment of the invention, a center distance between the tenth lens and the eleventh lens is a maximum among center distances between adjacent lenses, and a center thickness of the ninth lens may be a largest center thicknesses of the first to eleventh lenses.

According to an embodiment of the invention, an angle of view of the optical system is FOV, an optical axis distance from a center of the object-side surface of the first lens to an upper surface of an image sensor is TTL, a total number of lenses is n, and the following Equation may satisfy: FOV<(TTL*n).

According to an embodiment of the invention, the object-side surface of the ninth lens has a critical point, and the critical point of the sensor-side surface of the eleventh lens may be disposed closer to an edge than a critical point of the object-side surface of the ninth lens.

According to an embodiment of the invention, a refractive index (n1) of the first lens satisfies the condition: 16<n1*n<18, and a refractive index n11 of the eleventh lens satisfies the condition: 16<n11*n<18, and a refractive index of the third lens is n3, where n is the total number of lenses, and the following Equation may satisfy: 17<n3*n.

According to an embodiment of the invention, a number of lenses with a refractive index of less than 1.6 among the first to eleventh lenses is 6 or more, refractive indices of the first, second, and third lenses are n1, n2, and n3, Abbe numbers of the three lenses are v1, v2, and v3, and the following Equations may satisfy: (v3*n3)<(v1*n1) and (v3*n3)<(v2*n2).

According to an embodiment of the invention, a sum of effective diameters of object-side surfaces and sensor-side surfaces of the first to eleventh lenses is ΣCA, the total number of lenses is n, and the following Equation may satisfy: ΣCA*n>1350.

An optical system according to an embodiment of the invention includes a first lens having a meniscus shape convex toward an object side; a second lens disposed on a sensor side of the first lens; n-th lens closest to an image sensor; an n−1th lens disposed on an object side of the n-th lens; and five or more lenses disposed between the second lens and the n−1th lens, wherein one of the lenses disposed between the second lens and the n−1th lens has a minimum effective diameter, the n-th lens has an maximum effective diameter among the lenses of the optical system, a sum of the center thicknesses of the lenses is ΣCT, the sum of optical axis distances between two adjacent lenses is ΣCG, and a maximum of center thickness of the lenses is CT_Max, a maximum of the optical axis distances between the adjacent lenses is CG_Max, n is the total number of lenses in the optical system, and the following Equations may satisfy: 1<ΣCT/ΣCG<2.5 and 10<(CT_Max+CG_Max)*n<30.

According to an embodiment of the invention, the object-side surface and the sensor-side surface of the n−1th lens may have a critical point.

According to an embodiment of the invention, the n-th lens has a meniscus shape convex toward the object side, the n−1th lens has a meniscus shape convex toward the sensor side, and a sensor-side surface of the n-th lens may have a critical point between the optical axis to an effective region.

According to an embodiment of the invention, an object-side surface and a sensor-side surface of the n−1th lens may be provided without a critical point from the optical axis to an end of an effective region.

According to an embodiment of the invention, the optical axis distance between the n-th lens and the n−1th lens is CG10, the center thickness of the n-th lens is CT11, and the following Equation may satisfy: 2<CG10/CT11<3.

According to an embodiment of the invention, the sum of the center thicknesses from the first lens to the n-th lens is ΣCT, the sum of the center distances between two adjacent lenses is ΣCG, the total number of lenses is n, and the following Equations may satisfy: ΣCT*n>45 and ΣCG*n>30.

According to an embodiment of the invention, a largest effective diameter between the object-side surface and a sensor-side surface of each lens is CA_Max, and ½ of a maximum diagonal length of the image sensor is Imgh, and the following Equation may satisfy: 0.5<CA_Max/(2*Imgh)<1.

According to an embodiment of the invention, an optical axis distance from a center of the object-side surface of the first lens to the upper surface of the image sensor is TTL, ½ of the maximum diagonal length of the image sensor is Imgh, and an effective focal length of the optical system is F, a maximum separation distance from a center of the sensor-side surface of the n-th lens to a lens surface in a direction of the optical axis based on a straight line extending perpendicular to the optical axis is Max_Sag112, the total number of lenses is n, and the following Equation may satisfy: 10<(TTL/Imgh)*|Max_Sag112|*n<25.

An optical system according to an embodiment of the invention includes a first lens group having a plurality of lenses; a second lens group having more lenses than the first lens group; and an aperture stop disposed between the lenses of the first lens group, wherein the first lens group has a concave sensor-side surface closest to the second lens group, the second lens group includes an convex object-side surface closest to the first lens group, a maximum effective diameter among the lenses of the first and second lens groups is CA_Max, an optical axis distance from a center of an object-side surface of a first lens in the first lens group to a sensor-side surface of a last lens in the second lens group is TD, a total number of lenses is n, and the following Equation may satisfy: 1000<CA_Max*TD*n<1500.

According to an embodiment of the invention, the first lens group has a different number of lenses with positive refractive power and a number of lenses with negative refractive power, and the second lens group may have the same number of lenses with positive refractive power and lenses with negative refractive power, the first lens of the first lens group may have positive refractive power, and the last lens of the second lens group may have a sensor-side surface having a critical point and negative refractive power.

According to an embodiment of the invention, a sum of center thicknesses of the lenses of the first and second lens groups is ΣCT, a sum of an optical axis distances between two adjacent lenses is ΣCG, the total number of lenses in the optical system is n, and the following Equation may satisfy: 11<(ΣCT/ΣCG)*n<19.8.

A camera module according to an embodiment of the invention includes an image sensor; and an optical filter disposed between the image sensor and a last lens, wherein an optical system includes the optical system disclosed above, a total focal length is F, a distance in the optical axis from a center of an object-side surface of a lens closest to an object to an upper surface of the image sensor is TTL, ½ of a maximum diagonal length of the image sensor is Imgh, a total number of lenses is n, and the following Equation may satisfy: 0.5<F/TTL<1.5, 0.5<TTL/Imgh<3, and 44≤Imgh*n≤110.

### Advantageous Effects

The optical system and the camera module according to the embodiment may have improved optical properties. In detail, the optical system may have improved aberration characteristics and resolving power according to the surface shape, refractive power, thickness of a plurality of lenses and distance between adjacent lenses of a plurality of lenses.

The optical system and the camera module according to the embodiment may have improved distortion and aberration characteristics, and may have good optical performance at the center and periphery portions of the FOV.

The optical system according to the embodiment may have improved optical characteristics and a small total track length (TTL), so that the optical system and a camera module including the same may be provided in a slim and compact structure.

### DESCRIPTION OF DRAWINGS

FIG. 1 is a configuration diagram of an optical system and a camera module according to an embodiment of the invention.

FIG. 2 is an explanatory diagram showing the relationship between the image sensor, n-th, n−1th, and n−2th lenses of the optical system of FIG. 1.

FIG. 3 is a table showing lens data of the optical system of FIG. 1.

FIG. 4 is an example of aspherical coefficients of lenses according to an embodiment of the invention.

FIG. 5 is a table showing the thickness of the lenses and the distances between the lenses according to the direction orthogonal to the optical axis in the optical system according to the first embodiment of the invention.

FIG. 6 is a table showing Sag values of the object-side surface and the sensor-side surface of the seventh to eleventh lenses in the optical system of FIG. 1.

FIG. 7 is a table showing the inclination angles of the object-side surface and the sensor-side surface of the seventh to eleventh lenses in the optical system of FIG. 1.

FIG. 8 is a graph of the diffraction MTF of the optical system of FIG. 1.

FIG. 9 is a graph showing the aberration characteristics of the optical system of FIG. 1.

FIG. 10 is a graph showing a two-dimensional function of a curve connecting points passing through the ends of the effective regions of lenses according to an embodiment of the invention.

FIG. 11 is a graph showing a straight line connecting points passing through the end of the effective region from the sensor-side surfaces of the third lens to the n-th lens according to an embodiment of the invention as a one-dimensional function.

FIG. 12 is a graph showing Sag values of the object-side surface and sensor-side surface of the n-th, n−1th, and n−2th lenses of the optical system of FIG. 1.

FIG. 13 is a diagram showing a camera module according to an embodiment applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

Further, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The effective diameter on the lens surface may have a measurement error of up to ±0.4 mm depending on the measurement method. The paraxial region refers to a very narrow region near the optical axis, and is a region in which a distance at which a light ray falls from the optical axis OA is almost zero. Hereinafter, the concave or convex shape of the lens surface will be described as an optical axis, and may also include a paraxial region.

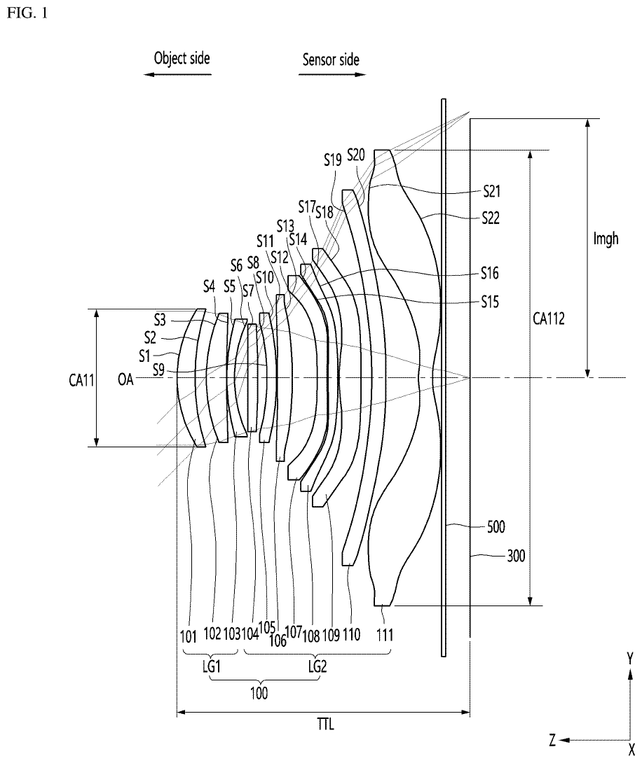

FIG. 1 is a diagram showing an optical system 1000 and a camera module having the same according to embodiments of the invention.

Referring to FIG. 1, the optical system 1000 or camera module may include a lens portion 100 having a plurality of lens groups LG1 and LG2. In detail, each of the plurality of lens groups LG1 and LG2 includes at least two lenses. For example, the optical system 1000 may include a first lens group LG1 and a second lens group LG2 sequentially arranged along the optical axis OA from the object side toward the image sensor 300. The number of lenses of the second lens group LG2 may be greater than the number of lenses of the first lens group LG1, for example, may be two to three times the number of lenses of the first lens group LG1.

The first lens group LG1 may include two or more lenses, for example, 2 to 3 lenses. The second lens group LG2 may include 5 or more lenses, for example, 9 or fewer lenses or 7 or more lenses. The number of lenses of the second lens group LG2 may be 7 or more than the number of lenses of the first lens group LG1. The total number of lenses in the first and second lens groups LG1 and LG2 is 10 to 12. For example, the first lens group LG1 may include 3 lenses, and the second lens group LG2 may include 9 lenses.

In the optical system 1000, the TTL may be less than 70% of the diagonal length of the image sensor 300, for example, in the range of 40% to 69% or 50% to 60%. The TTL is the distance in the optical axis OA from the object-side surface of the first lens 101 closest to the object side to the upper surface of the image sensor 300, and the diagonal length of the image sensor 300 is a maximum diagonal length of the image sensor 300 and may be twice the distance (Imgh) from the optical axis OA to the end of the diagonal. Accordingly, a slim optical system and a camera module having the same may be provided.

The first lens group LG1 refracts the light incident through the object side to gather, and the second lens group LG2 may refract the light emitted through the first lens group LG1 to spread to the periphery of the image sensor 300.

The first lens group LG1 may have positive (+) refractive power. The second lens group LG2 may have a negative refractive power that is opposite to that of the first lens group LG1. The first lens group LG1 and the second lens group LG2 have different focal lengths and opposite refractive powers, thereby providing good optical performance in the center and periphery portions of the FOV. The refractive power is the reciprocal of the focal length.

When expressed as an absolute value, the focal length of the second lens group LG2 may be greater than the focal length of the first lens group LG1. For example, the absolute value of the focal length F_LG2 of the second lens group LG2 may be 1.1 times or more, for example, in a range of 1.1 to 7 times the absolute value of the focal length F_LG1 of the first lens group LG1. Accordingly, the optical system 1000 according to the embodiment may have improved aberration control characteristics such as chromatic aberration and distortion aberration by controlling the refractive power and focal length of each lens group, and may have good optical performance in the center and periphery portions of the FOV.

In the optical axis OA, the first lens group LG1 and the second lens group LG2 may have a set distance. The optical axis distance between the first lens group LG1 and the second lens group LG2 on the optical axis OA is the separation distance in the optical axis OA, and may be an optical axis distance between the sensor-side surface of the lens closest to the sensor side among the lenses in the first lens group LG1 and the object-side surface of the lens closest to the object side among the lenses in the second lens group LG2.

The optical axis distance between the first lens group LG1 and the second lens group LG2 may be smaller than a center thickness of a lens located at the last of the lenses of the first lens group LG1 and may be greater than a center thickness of a lens located at the first of the lenses of the second lens group LG2. The optical axis distance between the first lens group LG1 and the second lens group LG2 is smaller than the optical axis distance of the first lens group LG1 and is 32% or less of the optical axis distance of the first lens group LG1, for example, in the range of 12% to 32% or 17% to 27% of the optical axis distance of the first lens group LG1. Here, the optical axis distance of the first lens group LG1 is a distance in the optical axis between the object-side surface of the lens closest to the object side of the first lens group LG1 and the sensor-side surface of the lens closest to the sensor side.

The optical axis distance between the first lens group LG1 and the second lens group LG2 may be 15% or less of the optical axis distance of the second lens group LG2, for example, in a range of 2% to 15% or 2% to 12%. The optical axis distance of the second lens group LG2 is a distance in the optical axis between the object-side surface of the lens closest to the object side of the second lens group LG2 and the sensor-side surface of the n-th lens. Here, the n-th lens is the last lens, and in the specification, n is any one of n=9, 10, 11, or 12.

Here, the optical axis distance of the first lens group LG1 is D_LG1, the optical axis distance of the second lens group LG2 is D_LG2, and the total number of lenses is n (n=9, 10, 11, or 12). In one case, the following Equations may satisfy: 0<D_LG1/n<0.2 and 0.3<D_LG2/n<0.7.

Additionally, when the optical axis distance from the object-side surface of the first lens to the sensor-side surface of the n-th lens is TD, the following Equation may satisfy: 0.5<TD/n<1. When a sum of the effective diameters from the object-side surface of the first lens to the sensor-side surface of the last n-th lens is ΣCA, the following Equation may satisfy: 8<ΣCA/n<15. Additionally, when the sum of the center thicknesses from the first lens to the last lens is ΣCT, the following Equation may satisfy: 0.3<ΣCT/n<0.6, and when the sum of the center distances between two adjacent lenses is ΣCG, the following Equation may satisfy: 2<ΣCG<ΣCT. The n is the total number of lenses. Accordingly, a slim optical system may be provided.

The lens with the smallest effective diameter within the first lens group LG1 may be the lens closest to the second lens group LG2. The lens with the smallest effective diameter within the second lens group LG2 may be the lens closest to the first lens group LG1. Here, the effective diameter of each lens is the average value of the effective diameter of the object-side surface and the effective diameter of the sensor-side surface of each lens. Accordingly, the optical system 1000 may have good optical performance not only in the center of the FOV but also in the periphery portion, and may improve chromatic aberration and distortion aberration. The size of the lens with the minimum effective diameter in the first lens group LG1 may be smaller than the size of the lens with the minimum effective diameter in the second lens group LG2. Here, the FOV may satisfy: 6.5<FOV/n<12 for the total number n of lenses. Accordingly, a slim telephoto camera module may be provided.

The lens closest to the object side in the first lens group LG1 may have positive (+) refractive power, and the lens closest to the sensor side in the second lens group LG2 may have negative (−) refractive power. In the optical system 1000, the number of lenses with positive (+) refractive power may be greater than the number of lenses with negative (−) refractive power. In the first lens group LG1, the number of lenses with positive (+) refractive power may be greater than the number of lenses with negative (−) refractive power. In the second lens group LG2, the number of lenses with positive (+) refractive power may be equal to or greater than the number of lenses with negative (−) refractive power.

Each of the plurality of lenses 100 may include an effective region and a non-effective region. The effective region may be a region through which light incident on each of the lenses 100 passes. That is, the effective region may be an effective region or an effective diameter region in which the incident light is refracted to realize optical characteristics. The non-effective region may be arranged around the effective region. The non-effective region may be a region where effective light does not enter the plurality of lenses 100. That is, the non-effective region may be a region unrelated to the optical characteristics. Additionally, the end of the non-effective region may be a region fixed to a barrel (not shown) that accommodates the lens.

The optical system 1000 may include an image sensor 300 on the sensor side of the lens portion 100. The image sensor 300 may detect light and convert it into an electrical signal. The image sensor 300 may detect light that sequentially passes through the plurality of lenses 100. The image sensor 300 may include an element capable of detecting incident light, such as a charge coupled device (CCD) or a complementary metal oxide semiconductor (CMOS). The diagonal length of the image sensor 300 may be greater than 2 mm, for example, greater than 4 mm and less than 12 mm. Preferably, Imgh of the image sensor 300 may be smaller than TTL.

The optical system 1000 may include an optical filter 500. The optical filter 500 may be disposed between the second lens group LG2 and the image sensor 300. The optical filter 500 may be disposed between the image sensor 300 and the n-th lens closest to the image sensor 300 among the plurality of lenses 100. For example, when the optical system 100 has 11 lenses, the optical filter 500 may be disposed between the eleventh lens 111 and the image sensor 300.

The optical filter 500 may include an infrared filter. The optical filter 500 may pass light in a set wavelength band and filter light in a different wavelength band. When the optical filter 500 includes an infrared filter, radiant heat emitted from external light may be blocked from being transmitted to the image sensor 300. Additionally, the optical filter 500 may transmit visible light and reflect infrared rays. As another example, a cover glass may be further disposed between the optical filter 500 and the image sensor 300.

The optical system 1000 according to the embodiment may include an aperture stop ST. The aperture stop ST may control the amount of light incident on the optical system 1000. The aperture stop ST may be disposed around at least one lens of the first lens group LG1. For example, the aperture stop ST may be disposed around the object-side surface or sensor-side surface of the second lens 102. The aperture stop ST may be disposed between two adjacent lenses 102 and 103 among the lenses in the first lens group LG1. Alternatively, at least one lens selected from among the plurality of lenses 100 may function as an aperture stop. In detail, the object-side surface or the sensor-side surface of one lens selected from among the lenses of the first lens group LG1 may function as an aperture stop to adjust the amount of light.

The straight distance from the aperture stop ST to the sensor-side surface of the n-th lens may be smaller than the optical axis distance from the object-side surface of the first lens 101 to the sensor-side surface of the n-th lens. When the optical axis distance from the aperture stop ST to the sensor-side surface of the n-th lens is SD, the following Equation may satisfy: SD<EFL. Additionally, it may satisfy: SD<Imgh. The EFL is the effective focal length of the total optical system and may be defined as F. The EFL and Imgh may be the same or different from each other and may have a difference of 2 mm or less. The FOV of the optical system 1000 may be less than 120 degrees, for example, more than 70 degrees and less than 100 degrees. The F number F # of the optical system 1000 may be greater than 1 and less than 10, for example, 1.1≤F #≤5. Additionally, the F # may be smaller than the entrance pupil diameter (EPD). Accordingly, the optical system 1000 has a slim size, may control incident light, and may have improved optical characteristics within the FOV.

The effective diameter of the lenses gradually decreases from the object-side lens to the sensor-side surface (e.g., S6) of the first lens group LG1, and may gradually increase from the sensor-side surface of the first lens group to the lens surface of the last lens. Additionally, the effective diameter of the first lens group LG1 may gradually become smaller from the object-side surface of the object-side first lens 101 to the lens surface where the aperture stop is disposed.

The optical system 1000 according to the embodiment may further include a reflective member (not shown) to change the path of light. The reflective member may be implemented as a prism that reflects incident light from the first lens group LG1 in the direction of the lenses. Hereinafter, the optical system according to the embodiment will be described in detail.

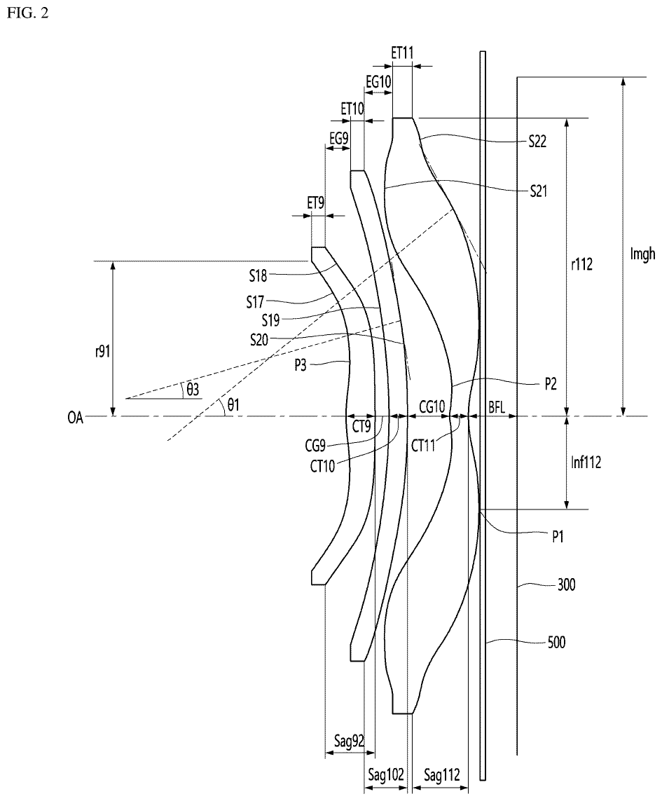

FIG. 1 is a configuration diagram of an optical system and a camera module according to a first embodiment of the invention, and FIG. 2 is an explanatory diagram showing the relationship between the image sensor and the n-th, n−1th, and n−2th lenses of the optical system of FIG. 1.

Referring to FIGS. 1 and 2, the optical system 1000 according to embodiments includes a lens portion 100 having a plurality of lenses, and a lens portion 100 includes first lenses 101 to eleventh lenses 111 may be included. The first to eleventh lenses 101-111 may be sequentially aligned along the optical axis OA of the optical system 1000. Light corresponding to object information may pass through the first to eleventh lenses 101 to 111 and the optical filter 500 and be incident on the image sensor 300.

The first lens group LG1 may include the first to third lenses 101-103, and the second lens group LG2 may include the fourth to eleventh lenses 104-111. The optical axis distance between the third lens 103 and the fourth lens 104 may be the optical axis distance between the first and second lens groups LG1 and LG2.

Among the first to eleventh lenses 101-111, the number of lenses having a meniscus shape convex from the optical axis toward the object may be four or more, and may be less than 50%. In each lens 101-103 of the first lens group LG1, a number of lens surfaces having a positive curvature radius may be greater than the lens surface having a negative curvature radius, and in each lens 104-111 of the second lens group LG2, a number of lens surfaces with a negative curvature radius may be greater than the number of lens surfaces with a positive curvature radius.

The first lens 101 may have negative (−) or positive (+) refractive power on the optical axis OA, and preferably may have positive (+) refractive power. The first lens 101 may include plastic or glass. For example, the first lens 101 may be made of plastic.

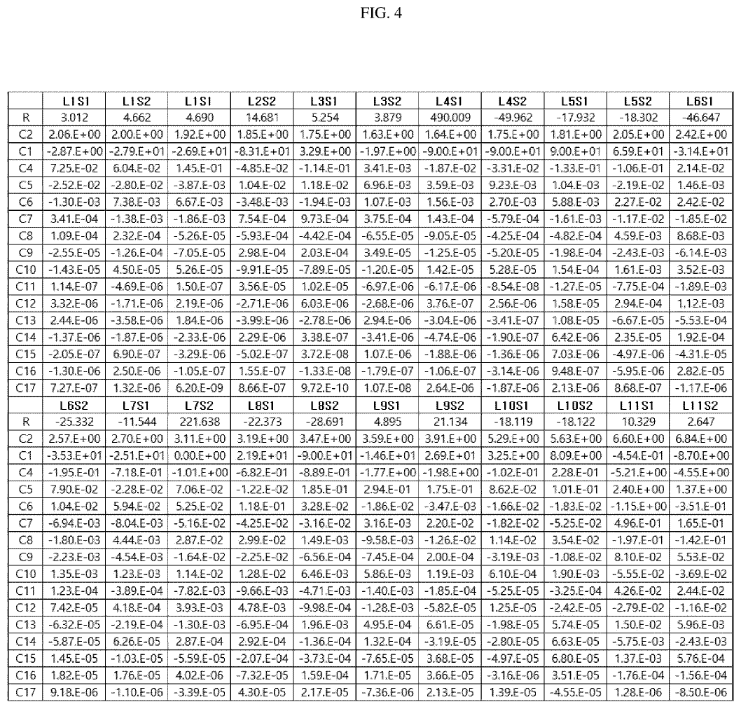

The first lens 101 may include a first surface S1 defined as the object-side surface and a second surface S2 defined as the sensor-side surface. On the optical axis OA, the first surface S1 may have a convex shape, and the second surface S2 may have a concave shape. That is, the first lens 101 may have a meniscus shape that is convex toward the object on the optical axis OA. At least one of the first surface S1 and the second surface S2 may be an aspherical surface. For example, both the first surface S1 and the second surface S2 may be aspherical. The aspherical coefficients of the first and second surfaces S1 and S2 are provided as shown in FIG. 4, where L1 is the first lens 101, L1S1 is the first surface, and L1S2 is the second surface.

The second lens 102 may have positive (+) or negative (−) refractive power on the optical axis OA. The second lens 102 may have positive (+) refractive power. The second lens 102 may include plastic or glass. For example, the second lens 102 may be made of plastic.

The second lens 102 may include a third surface S3 defined as the object-side surface and a fourth surface S4 defined as the sensor-side surface. On the optical axis OA, the third surface S3 may have a convex shape, and the fourth surface S4 may have a concave shape. That is, the second lens 102 may have a meniscus shape that is convex toward the object on the optical axis OA. Differently, on the optical axis OA, the third surface S3 may have a convex shape, and the fourth surface S4 may have a convex shape. At least one of the third surface S3 and the fourth surface S4 may be an aspherical surface. For example, both the third surface S3 and the fourth surface S4 may be aspherical. The aspherical coefficients of the third and fourth surfaces S3 and S4 are provided as shown in FIG. 4, where L2 is the second lens 102, L2S1 is the third surface, and L2S2 is the fourth surface.

The third lens 103 may have positive (+) or negative (−) refractive power on the optical axis OA, and may preferably have negative (−) refractive power. The third lens 103 may include plastic or glass. For example, the third lens 103 may be made of plastic.

The third lens 103 may include a fifth surface S5 defined as the object-side surface and a sixth surface S6 defined as the sensor-side surface. On the optical axis OA, the fifth surface S5 may have a convex shape, and the sixth surface S6 may have a concave shape. That is, the third lens 103 may have a meniscus shape that is convex toward the object on the optical axis OA. Differently, on the optical axis OA, the fifth surface S5 may have a convex shape, and the sixth surface S6 may have a convex shape. At least one of the fifth surface S5 and the sixth surface S6 may be an aspherical surface. For example, both the fifth surface S5 and the sixth surface S6 may be aspherical. The aspheric coefficients of the fifth and sixth surfaces S5 and S6 are provided as shown in FIG. 4, where L3 is the third lens 103, L3S1 is the fifth surface, and L3S2 is the sixth surface.

The fourth lens 104 may have positive (+) or negative (−) refractive power on the optical axis OA. The fourth lens 104 may have positive (+) refractive power. The fourth lens 104 may include plastic or glass. For example, the fourth lens 104 may be made of plastic.

The fourth lens 104 may include a seventh surface S7 defined as the object-side surface and an eighth surface S8 defined as the sensor-side surface. On the optical axis OA, the seventh surface S7 may have a convex shape, and the eighth surface S8 may have a convex shape. That is, the fourth lens 104 may have a shape in which both sides are convex at the optical axis OA. Alternatively, the seventh surface S7 may have a concave shape with respect to the optical axis OA, and the eighth surface S8 may have a convex shape with respect to the optical axis OA. That is, the fourth lens 104 may have a meniscus shape that is convex toward the sensor on the optical axis OA. Alternatively, the fourth lens 104 may have a concave shape on both sides of the optical axis OA. At least one of the seventh surface S7 and the eighth surface S8 may be an aspherical surface. For example, both the seventh surface S7 and the eighth surface S8 may be aspherical. The aspherical coefficients of the seventh and eighth surfaces S7 and S8 are provided as shown in FIG. 4, where L4 is the fourth lens 104, L4S1 is the seventh surface, and L4S2 is the eighth surface.

The two lenses 103 and 104 adjacent to the region between the first and second lens groups LG1 and LG2 may satisfy the following conditions.
Condition 1: Refractive index of a lens with positive refractive power<Refractive index of a lens with negative refractive power
Condition 2: Dispersion value of a lens with positive refractive power>Dispersion value of a lens with negative refractive power

Accordingly, chromatic aberrations generated between the lenses may be mutually corrected.

The fifth lens 105 may have positive (+) or negative (−) refractive power on the optical axis OA. The fifth lens 105 may have negative refractive power. The fifth lens 105 may include plastic or glass. For example, the fifth lens 105 may be made of plastic.

The fifth lens 105 may include a ninth surface S9 defined as the object-side surface and a tenth surface S10 defined as the sensor-side surface. On the optical axis OA, the ninth surface S9 may have a concave shape, and the tenth surface S10 may have a convex shape. That is, the fifth lens 105 may have a meniscus shape that is convex toward the sensor on the optical axis OA. Differently, on the optical axis OA, the ninth surface S9 may have a concave shape, and the tenth surface S10 may have a concave shape. Alternatively, the fifth lens may have a shape in which both sides are convex.

The fifth lens 105 may be provided with the ninth and tenth surfaces S9 and S10 without a critical point from the optical axis OA to the end of the effective region. At least one of the ninth surface S9 and the tenth surface S10 may be an aspherical surface. For example, both the ninth surface S9 and the tenth surface S10 may be aspherical. The aspheric coefficients of the ninth and tenth surfaces S9 and S10 are provided as shown in FIG. 4, where L5 is the fifth lens 105, L5S1 is the ninth surface, and L5S2 is the tenth surface.

The sixth lens 106 may have positive (+) or negative (−) refractive power on the optical axis OA. The sixth lens 106 may have positive (+) refractive power. The sixth lens 106 may include plastic or glass. For example, the sixth lens 106 may be made of plastic.

The sixth lens 106 may include an eleventh surface S11 defined as the object-side surface and a twelfth surface S12 defined as the sensor-side surface. On the optical axis OA, the eleventh surface S11 may have a concave shape, and the twelfth surface S12 may have a convex shape. That is, the sixth lens 106 may have a meniscus shape that is convex toward the sensor on the optical axis OA. Alternatively, the sixth lens 106 may have a shape with both sides concave or both sides convex on the optical axis OA. Alternatively, the sixth lens 106 may have a meniscus shape that is convex toward the object.

At least one of the eleventh surface S11 and the twelfth surface S12 may be an aspherical surface. For example, both the eleventh surface S11 and the twelfth surface S12 may be aspherical. The aspheric coefficients of the eleventh and twelfth surfaces S11 and S12 are provided as shown in FIG. 4, where L6 is the sixth lens 106, L6S1 is the eleventh surface, and L6S2 is the twelfth surface.

The seventh lens 107 may have positive (+) or negative (−) refractive power on the optical axis OA. The seventh lens 107 may have negative refractive power. The seventh lens 107 may include plastic or glass. For example, the seventh lens 107 may be made of plastic.

The seventh lens 107 may include a thirteenth surface S13 defined as the object-side surface and a fourteenth surface S14 defined as the sensor-side surface. On the optical axis OA, the thirteenth surface S13 may have a concave shape, and the fourteenth surface S14 may have a concave shape. That is, the seventh lens 107 may have a concave shape on both sides of the optical axis OA. Alternatively, the seventh lens 107 may have a meniscus shape that is convex toward the sensor. Alternatively, the seventh lens 107 may have a shape in which both sides are convex on the optical axis OA. Alternatively, the sixth lens 107 may have a meniscus shape that is convex toward the object.

At least one of the thirteenth surface S13 and the fourteenth surface S14 may be an aspherical surface. For example, both the thirteenth surface S13 and the fourteenth surface S14 may be aspherical. The aspheric coefficients of the thirteenth and fourteenth surfaces S13 and S14 are provided as shown in FIG. 4, where L7 is the seventh lens 107, L7S1 is the thirteenth surface, and L7S2 is the fourteenth surface.

At least one of the thirteenth surface S13 and the fourteenth surface S14 of the seventh lens 107 may have a critical point. For example, the thirteenth surface S13 may be provided without a critical point up to the end of the effective region of the thirteenth surface S13 based on the optical axis OA. The fourteenth surface S14 may have a critical point, and the critical point may be located at a distance of 42% or less of the effective radius from the optical axis OA, for example, in the range of 22% to 42% or in the range of 27% to 37%. The critical point is a point at which the sign of the slope value with respect to the optical axis OA and the direction perpendicular to the optical axis OA changes from positive (+) to negative (−) or from negative (−) to positive (+), and may mean a point at which the slope value is zero. Also, the critical point may be a point at which the slope value of a tangent passing through the lens surface increases as it decreases, or a point where the slope value decreases as it increases.

The eighth lens 108 may have positive (+) or negative (−) refractive power on the optical axis OA. The eighth lens 108 may have negative refractive power. The eighth lens 108 may include plastic or glass. For example, the eighth lens 108 may be made of plastic.

The eighth lens 108 may include a fifteenth surface S15 defined as the object-side surface and a sixteenth surface S16 defined as the sensor-side surface. On the optical axis OA, the fifteenth surface S15 may have a concave shape, and the sixteenth surface S16 may have a convex shape. That is, the eighth lens 108 may have a meniscus shape that is convex toward the sensor on the optical axis OA. Alternatively, the eighth lens 108 may have a concave shape on both sides. Alternatively, the eighth lens 108 may have a meniscus shape that is convex toward the object. Alternatively, the eighth lens 108 may have a shape in which both sides are convex on the optical axis OA.

At least one of the fifteenth surface S15 and the sixteenth surface S16 of the eighth lens 107 may be an aspherical surface. For example, both the fifteenth surface S15 and the sixteenth surface S16 may be aspherical. The aspheric coefficients of the fifteenth and sixteenth surfaces S15 and S16 are provided as shown in FIG. 4, where L8 is the eighth lens 108, L8S1 is the fifteenth surface, and L8S2 is the sixteenth surface.

At least one or both of the fifteenth surface S15 and the sixteenth surface S16 of the eighth lens 108 may have a critical point. For example, the critical point of the fifteenth surface S15 may be located at 41% or less of the effective radius from the optical axis OA, for example, in the range of 21% to 41% or in the range of 26% to 36%. Here, the sixteenth surface S16 may be provided without a critical point from the optical axis to the end of the effective region. On the optical axis OA, the critical point of the fifteenth surface S15 and the critical point of the fourteenth surface S14 may have a difference of 0.3 mm or less, so that the fourteenth and fifteenth surfaces S14 and S15 may guide effectively the traveling light.

The ninth lens 109 may have positive (+) or negative (−) refractive power on the optical axis OA. The ninth lens 109 may have negative (−) refractive power. The ninth lens 109 may include plastic or glass. For example, the ninth lens 109 may be made of plastic.

The ninth lens 109 may include a seventeenth surface S17 defined as the object-side surface and an eighteenth surface S18 defined as the sensor-side surface. On the optical axis OA, the seventeenth surface S17 may have a convex shape, and the eighteenth surface S18 may have a concave shape. That is, the ninth lens 109 may have a meniscus shape that is convex toward the object on the optical axis OA. Alternatively, the ninth lens 109 may have a meniscus shape that is convex toward the sensor on the optical axis OA, or may have a concave or convex shape on both sides.

At least one or both of the seventeenth surface S17 and the eighteenth surface S18 of the ninth lens 109 may have a critical point from the optical axis to the end of the effective region. The critical point (see P3 in FIG. 2) of the seventeenth surface S17 may be located at a position of 30% or more of the effective radius from the optical axis, for example, in the range of 30% to 50% or 35% to 45%. The critical point of the eighteenth surface S18 may be located at a position less than 33% of the effective radius from the optical axis, for example, in the range of 13% to 33% or in the range of 18% to 28%. Since the critical point of the eighteenth surface S18 is located closer to the optical axis than the critical point of the seventeenth surface S17, incident light may be refracted toward the center and periphery portions of the image sensor 300.

At least one of the seventeenth surface S17 and the eighteenth surface S14 of the ninth lens 109 may be an aspherical surface. For example, both the seventeenth surface S17 and the eighteenth surface S18 may be aspherical. The aspherical coefficients of the seventeenth and eighteenth surfaces S17 and S18 are provided as shown in FIG. 4, where L9 is the ninth lens 109, L9S1 is the seventeenth surface, and L9S2 is the eighteenth surface.

The tenth lens 110 may have positive (+) or negative refractive power on the optical axis OA, for example, may have positive refractive power. The tenth lens 110 may include plastic or glass. For example, the tenth lens 110 may be made of plastic. The tenth lens 110 may be the n−1th lens in the optical system 1000.

The tenth lens 110 may include a nineteenth surface S19 that is concave on the object side and a twentieth surface S20 that is convex on the sensor side. The tenth lens 110 may have a meniscus shape convex toward the sensor. Alternatively, the tenth lens 110 may have a meniscus shape that is convex toward the object on the optical axis OA. Alternatively, the tenth lens 110 may have a concave or convex shape on both sides of the optical axis OA. The nineteenth surface S19 and the twentieth surface S20 of the tenth lens 110 may be provided without a critical point from the optical axis to the end of the effective region. Accordingly, the effective diameter of the tenth lens 110 does not have a large difference from that of the eleventh lens 111 and may be provided with a thin thickness, so that light may be guided uniformly throughout the entire region.

Both the nineteenth surface S19 and the twentieth surface S20 of the tenth lens 110 may be aspherical. The aspheric coefficients of the nineteenth and twentieth surfaces S19 and S20 are provided as shown in FIG. 4, where L10 is the tenth lens 110, L10S1 is the nineteenth surface, and L10S2 is the twentieth surface.

The eleventh lens 111 may have negative refractive power on the optical axis OA. The eleventh lens 111 may include plastic or glass. For example, the eleventh lens 111 may be made of plastic. The eleventh lens 111 may be the n-th lens of the optical system 1000.

The eleventh lens 111 may include a twenty-first surface S21 defined as the object-side surface and a twenty-second surface S22 defined as the sensor-side surface. On the optical axis OA, the twenty-first surface S21 may have a convex shape, and the twenty-second surface S22 may have a concave shape. That is, the eleventh lens 111 may have a meniscus shape that is convex toward the object on the optical axis OA. Alternatively, the eleventh lens 111 may have a meniscus shape that is convex toward the sensor on the optical axis OA, or may have a concave or convex shape on both sides.

At least one of the twenty-first surface S21 and the twenty-second surface S22 of the eleventh lens 111 may be an aspherical surface. For example, both the twenty-first surface S21 and the twenty-second surface S22 may be aspherical. The aspheric coefficients of the twenty-first and twenty-second surfaces S21 and S22 are provided as shown in FIG. 4, where L11 is the eleventh lens 111, L11S1 is the twenty-first surface, and L11S2 is the twenty-second surface.

As shown in FIG. 2, the seventeenth surface S17 and the eighteenth surface S18 of the ninth lens 109 may have at least one critical point from the optical axis OA to the end of the effective region. The critical point P3 of the seventeenth surface S17 may be located at a distance of 50% or less of the effective radius r91, which is a distance from the optical axis OA to the end of the effective radius, for example, in the range of 30% to 50% or 35% to 45%.

The critical point of the eighteenth surface S18 may be disposed closer to the optical axis than the critical point P3 of the seventeenth surface S17, thereby guiding light traveling to the center portion of the image sensor.

When the distance from the optical axis to the critical point of the seventeenth surface S17 is Inf91, Inf91 may be arranged in the range of 1 mm to 1.8 mm based on the optical axis OA. The positions of the critical points of the ninth lens 109 are preferably arranged at positions that satisfy the above-mentioned range in consideration of the optical characteristics of the optical system 1000. In detail, it is desirable that the position of the critical point satisfies the above-mentioned range for controlling optical characteristics such as chromatic aberration, distortion characteristics, aberration characteristics, and resolution of the optical system 1000. Accordingly, the path of light emitted to the image sensor 300 through the lenses may be effectively controlled. Accordingly, the optical system 1000 according to the embodiment may have improved optical characteristics even in the center and peripheral portions of the FOV.

The twenty-first surface S21 and the twenty-second surface S22 of the eleventh lens 111 may have at least one critical point P1 and P2 from the optical axis OA to the end of the effective region. The critical point P2 of the twenty-first surface S21 may be located at a distance of 19% or less of the effective radius, which is the distance from the optical axis OA to the end of the effective radius, for example, in the range of 1% to 19% or in the range of 4% to 14%. The critical point P2 of the twenty-first surface S21 may be located closer to the optical axis than the critical point of the twenty-second surface S22 and the critical point of the ninth lens 109. Accordingly, the twenty-first surface S21 may change the refraction angle of light traveling around the critical point P2 and disperse the light toward the center portion of the image sensor 300.

The critical point P1 of the twenty-second surface S22 may be located at a distance Inf112 of 26% or more of the effective radius based on the optical axis OA, for example, in the range of 26% to 46% or in the range of 31% to 41%. The position of the critical point P1 of the twenty-second surface S22 may be located further outside the critical point of the twenty-first surface S21 and the critical point P1 of the ninth lens 109 based on the optical axis. The distance difference between the critical points P2 and P1 of the twenty-first surface S21 and the twenty-second surface S22 of the eleventh lens 111 on the optical axis may be 1 mm or more. The positions of the critical points P1 and P2 of the eleventh lens 111 are preferably located at positions that satisfy the above-mentioned range in consideration of the optical characteristics of the optical system 1000. In detail, it is desirable that the positions of the critical points P1 and P2 satisfy the above-mentioned range for controlling optical characteristics such as chromatic aberration, distortion characteristics, aberration characteristics, and resolution of the optical system 1000. Accordingly, the path of light emitted to the image sensor 300 through the lens may be effectively controlled. Accordingly, the optical system 1000 according to the embodiment may have improved optical characteristics even in the center and peripheral regions of the FOV.

The distance from the optical axis OA to the ends of the effective regions of each of the seventeenth surface S17 and the eighteenth surface S18 of the ninth lens 109 is the effective radius, and may be defined as r91 and r92. The distance from the optical axis OA to the ends of the effective regions of each of the twenty-first surface S21 and the twenty-second surface S22 of the eleventh lens 111 is the effective radius, and may be defined as r111 and r112.

Inf112: Straight distance from the center of the twenty-second surface S22 to the first critical point P1

Inf111: Straight distance from the center of the twenty-first surface S21 to the second critical point P2

Inf91: Straight distance from the center of the seventeenth surface S17 to the third critical point P3

Inf92: Straight distance from the center of the eighteenth surface S18 to the fourth critical point P4

The distance from the center of each lens surface to the critical point may have the following relationships.

$$Inf 111 < Inf 112$$

$$Inf 92 < Inf 91$$

$$Inf 111 < Inf 92 < Inf 91 < Inf 112$$

$$( Inf 91 - Inf 92 ) < ( Inf 112 - Inf 111 )$$

The distance from the effective radii r91, r92, r111, and r112 and the critical points P1, P2, P3, and P4 from the optical axis may satisfy the following Equations.

$$0.3 \leq Inf 91 / r 91 \leq 0.50$$

$$0.13 \leq Inf 92 / r 92 \leq 0.33$$

$$0.01 < Inf 111 / r 111 \leq 0.19$$

$$0.26 < Inf 112 / r 112 \leq 0. 46$$

The position of the first critical point P1 may be located at a distance of 1 mm or more with respect to the optical axis OA, for example, within a range of 1 mm to 3 mm, and the second critical point P2 may be located at a distance of 1.2 mm or less based on the optical axis OA, for example, within the range of 0.10 mm to 1.2 mm. The third critical point P3 may be located at a distance of 0.9 mm or more with respect to the optical axis, for example, within the range of 0.9 mm to 1.9 mm.

The first critical point P1 may be located closer to the optical axis OA than the first, second, and fourth critical points P2, P3, and P4, and the second critical point P2 is located closer to the optical axis OA than the first, second, and fourth critical points P2, P3, and P4 and may be located closer to the edge than the critical points P1 and P3. Accordingly, the ninth and eleventh lenses 197 and 111 may guide the incident light toward the center and periphery portion.

The normal line K2, which is a straight line perpendicular to the tangent line K1 passing through an arbitrary point on the sensor-side twenty-second surface S22 of the eleventh lens 111, which is the n-th lens, is set at a predetermined first angle θ1 with the optical axis OA, and when the first angle θ1 is maximum, it may be greater than 5 degrees and less than 65 degrees, for example, in the range of 20 degrees to 50 degrees or in the range of 25 degrees to 45 degrees. Accordingly, light may be guided from the periphery of the twenty-second surface S22 to the image sensor 300. In addition, the twenty-second surface S22 provides a Sag value (absolute value) of the lens surface extending in the object-side direction based on a straight line perpendicular to the optical axis OA greater than the Sag value (absolute value) extending in the sensor-side direction. Therefore, the TTL may be reduced and the size of the image sensor 300 may be increased.

The normal line K4, which is a straight line perpendicular to the tangent line K3 passing through an arbitrary point on the twentieth surface S20 on the sensor-side surface of the tenth lens 110, which is the n−1th lens, may have a predetermined second angle θ2 from the optical axis OA, and the maximum angle of the second angle θ2 may be greater than 5 degrees and less than 65 degrees, for example, in the range of 20 degrees to 50 degrees or 27 degrees to 47 degrees. Accordingly, since it has the minimum Sag value in the optical axis or paraxial region of the twenty-second surface S22, a slim optical system may be provided.

The maximum angle between the normal line passing through the twenty-first surface S21 of the eleventh lens 111 and the optical axis is θ3, and the maximum angle between the normal line passing through the nineteenth surface S19 of the tenth lens 110 and the optical axis is θ4, the maximum angle between a normal line perpendicular to the tangent line passing through the eighteenth surface S18 of the ninth lens 109 and the optical axis is θ5, and the maximum angle between a normal line passing through the eighteenth surface S18 of the ninth lens 109 the optical axis is θ6, when θ1 and θ2 are the maximum angles, and at least one of the following conditions may satisfy.

$$θ1 \leq θ 2 \qquad Condition 1$$

$$θ4 < θ3 \qquad Condition 2$$

$$θ3 \leq θ1 \qquad Condition 3$$

$$0 < ( θ1 - θ3 ) < 10 \qquad Condition 4$$

$$0 \leq ( θ2 - θ1 ) < 10 \qquad Condition 5$$

$$15 < ( θ 2 - θ 4 ) < 30 \qquad Condition 6$$

$$0 \leq ( θ 5 - θ 2 ) < 10 \qquad Condition 7$$

$$1 \leq ( θ 5 - θ 6 ) < 10 \qquad Condition 8$$

The curvature radii of the first and second surfaces S1 and S2 of the first lens 101 are L1R1 and L1R2,

The curvature radii of the third and fourth surfaces S3 and S4 of the second lens 102 are L2R1 and L2R2,

The curvature radii of the fifth and sixth surfaces S5 and S6 of the third lens 103 are L3R1 and L3R2,

The curvature radii of the seventh and eighth surfaces S7 and S8 of the fourth lens 104 are L4R1 and L4R2,

The curvature radii of the ninth and tenth surfaces S9 and S10 of the fifth lens 105 are L5R1 and L5R2,

The curvature radii of the eleventh and twelfth surfaces S11 and S12 of the sixth lens 106 are L6R1 and L6R2,

The curvature radii of the thirteenth and fourteenth surfaces S13 and S14 of the seventh lens 107 are L7R1 and L7R2,

The curvature radii of the fifteenth and sixteenth surfaces S15 and S16 of the eighth lens 108 are L8R1 and L8R2,

The curvature radii of the seventeenth and eighteenth surfaces S17 and S18 of the ninth lens 109 are L9R1 and L9R2,

The curvature radii of the nineteenth and twentieth surfaces S19 and S20 of the tenth lens 110 are L10R1 and L10R2,

The radii of curvature of the twenty-first and twenty-second surfaces S21 and S22 of the eleventh lens 111 may be defined as L11R1 and L11R2. The radii of curvature may satisfy at least one of the following conditions 1-9 to improve the aberration characteristics of the optical system. In the specification, * means multiplication.

$$L 1 R 1 < ( L 2 R 2 - L 2 R 1 ) \qquad Condition 1$$

$$L 1 R 1 + L 1 R 2 < L 2 R 2 \qquad Condition 2$$

$$L 3 R 1 + L 3 R 2 < L 2 R 2 \qquad Condition 3$$

$$( \vert L 4 R 2 \vert * 2 ) < L 4 R 1 \qquad Condition 4$$

$$\vert L 5 R 1 + L 5 R 2 \vert \text{<\textbar} L 4 R 2 \vert \qquad Condition 5$$

$$\vert L 6 R 1 + L 6 R 2 \vert < L 4 R 1 \qquad Condition 6$$

$$L 7 R 2 < L 4 R 1 < ( L 7 R 1 * 3 ) ( where , \vert L 7 R 1 \vert < \vert L 6 R 2 \vert ) \qquad Condition 7$$

$$\vert L 8 R 1 + L 8 R 2 \vert < L 7 R 2 \qquad Condition 8$$

$$L 9 R 1 * L 9 R 2 < L 7 R 2 \qquad Condition 9$$

$$\vert L 10 R 1 - L 10 R 2 \vert < L 9 R 2 - L 9 R 1 \qquad Condition 10$$

$$\vert L 10 R 1 - L 10 R 2 \vert < L 11 R 1 - L 11 R 2 \qquad Condition 11$$

The average of the radii of curvature of the first and second surfaces S1 and S2 of the first lens 101 on the optical axis OA may be the minimum in the optical system, the lens with the smallest difference in curvature radius between the object-side surface and the sensor-side surface of each lens may be the tenth lens, and the lens with the largest difference in curvature radius may be the fourth lens. The average of the radii (absolute value) of curvature of the third and fourth surfaces S3 and S4 of the third lens 103 may be the maximum within the optical system 1000. By setting the curvature radius of each lens, good optical performance may be provided at the focal length of each lens.

The effective diameters of the first to eleventh lenses 101-111 may be defined as ED1-ED11. The effective diameter ED11 of the eleventh lens 111 may have a maximum effective diameter of 8 mm or more. The effective diameter ED11 of the eleventh lens 111 is the average of the effective diameters of the object-side surface and the sensor-side surface. The effective diameter ED11 of the eleventh lens 111 may be more than twice the curvature radius of the object-side surface S1 of the first lens 101.

On the optical axis,

The effective diameters of the first and second surfaces S1 and S2 of the first lens 101 are CA11 and CA12,

The effective diameters of the third and fourth surfaces S3 and S4 of the second lens 102 are CA21 and CA22,

The effective diameters of the fifth and sixth surfaces S5 and S6 of the third lens 103 are CA31 and CA32,

The effective diameters of the seventh and eighth surfaces S7 and S8 of the fourth lens 104 are CA41 and CA42,

The effective diameters of the ninth and tenth surfaces S9 and S10 of the fifth lens 105 are CA51 and CA52,

The effective diameters of the eleventh and twelfth surfaces S11 and S12 of the sixth lens 106 are CA61 and CA62,

The effective diameters of the thirteenth and fourteenth surfaces S13 and S14 of the seventh lens 107 are CA71 and CA72,

The effective diameters of the fifteenth and sixteenth surfaces S15 and S16 of the eighth lens 108 are CA81 and CA82,

The effective diameters of the seventeenth and eighteenth surfaces S17 and S18 of the ninth lens 109 are CA91 and CA92,

The effective diameters of the nineteenth and twentieth surfaces S19 and S20 of the tenth lens 110 are CA101 and CA102.

The effective diameters of the twenty-first and twenty-second surfaces S21 and S22 of the eleventh lens 111 may be defined as CA111 and CA112. These effective diameters are factors that affect the aberration characteristics of the optical system, and may satisfy at least one of the following conditions.

$$CA 22 < CA 21 < CA 11 \qquad Condition 1$$

$$CA 32 < CA 31 < CA 22 < CA 21 \qquad Condition 2$$

$$CA 32 \leq CA 41 < CA 42 < CA 51 < CA 52 \qquad Condition 3$$

$$CA 52 < CA 61 < CA 62 < CA 71 < CA 72 \leq CA 81 \qquad Condition 4$$

$$Condition 5$$

$$CA 81 < CA 82 < CA 91 < CA 92 < CA 101 < CA 102 < CA 1101 < CA 1102$$

$$( CA 41 - CA 32 ) < ( CA 31 - CA 32 ) \qquad Condition 6$$

$$( CA 41 + CA 42 ) < CA 102 \qquad Condition 7$$

$$L 1 R 1 + L 1 R 2 < CA 82 \qquad Condition 8$$

$$( ED 1 * 2 ) < ED 11 \qquad Condition 9$$

$$( ED 3 * 3 ) < ED 11 \qquad Condition 10$$

Among the first to eleventh lenses 101-111, the average effective diameter of the lenses may be the smallest for the third lens 103 and the largest for the eleventh lens 111. In the optical system, the effective diameter of the sixth surface S6 or the seventh surface S7 may be the minimum, and the effective diameter of the twenty-second surface S22 may be the largest. The effective diameter of the eleventh lens 111 is the largest, so that incident light may be effectively refracted into the entire region of the image sensor 300. Accordingly, the optical system 1000 may have improved chromatic aberration control characteristics, and the vignetting characteristics of the optical system 1000 may be improved by controlling incident light.

In the optical system, the number of lenses with a refractive index exceeding 1.6 may be 5 or less, and may be smaller than the number of lenses with a refractive index of less than 1.6. In the optical system, the number of lenses less than 1.6 may be 6 or more or 7 or more. The average refractive index of the first to eleventh lenses 101-111 may be 1.52 or more. In the optical system, the number of lenses with an Abbe number greater than 45 may be smaller than the number of lenses with an Abbe number of less than 45, for example, 4 or more. The average Abbe number of the first to eleventh lenses 101-111 may be 45 or less. By setting the refractive index and Abbe number of each lens, the effect of chromatic aberration may be controlled.

Referring to FIG. 2, BFL is the optical axis distance from the image sensor 300 to the last lens. That is, BFL is the optical axis distance between the image sensor 300 and the sensor-side twenty-second surface S22 of the eleventh lens 111. CT10 is the center thickness or optical axis thickness of the tenth lens 110, and L10_ET is the end or edge thickness of the effective region of the tenth lens 110. CT11 is the center thickness or optical axis thickness of the eleventh lens 111. CG10 is the optical axis distance (i.e., center distance) from the center of the sensor-side surface of the tenth lens 110 to the center of the object-side surface of the eleventh lens 111. That is, the optical axis distance CG10 from the center of the sensor-side surface of the tenth lens 110 to the center of the object-side surface of the eleventh lens 111 is a distance between the twentieth surface S20 and the twenty-first surface S21 in the optical axis OA.

In this form, the center thickness of each of the first to eleventh lenses 101-111 may be expressed as CT1 to CT11, and the edge thickness at the end of the effective region may be expressed as ET1 to ET11.

Additionally, the center distance between the first and second lenses 101 and 102 is CG1, the center distance between the second and third lenses 102 and 103 is CG2, the center distance between the third and fourth lenses 103 and 104 is CG3, and the center distance between the fourth and third lenses 103 and 104 is CG3, the center distance between the fourth and fifth lenses 104 and 105 is CG4, the center distance between the fifth and sixth lenses 105 and 106 is CG5, the center distance between the sixth and seventh lenses 106 and 107 is CG6, and the center distance between the seventh and eighth lenses 107 and 108 is CG7, the center distance between the eighth and ninth lenses 108 and 109 is CG8, the center distance between the ninth and tenth lenses 109 and 110 is CG9, and the center distance between the ninth and tenth lenses 109 and 110 is CG9, and the center distance between the tenth and eleventh lenses 110 and 111 may be defied as CG10. The edge distance between the two adjacent lenses may be expressed as EG1 to EG10.

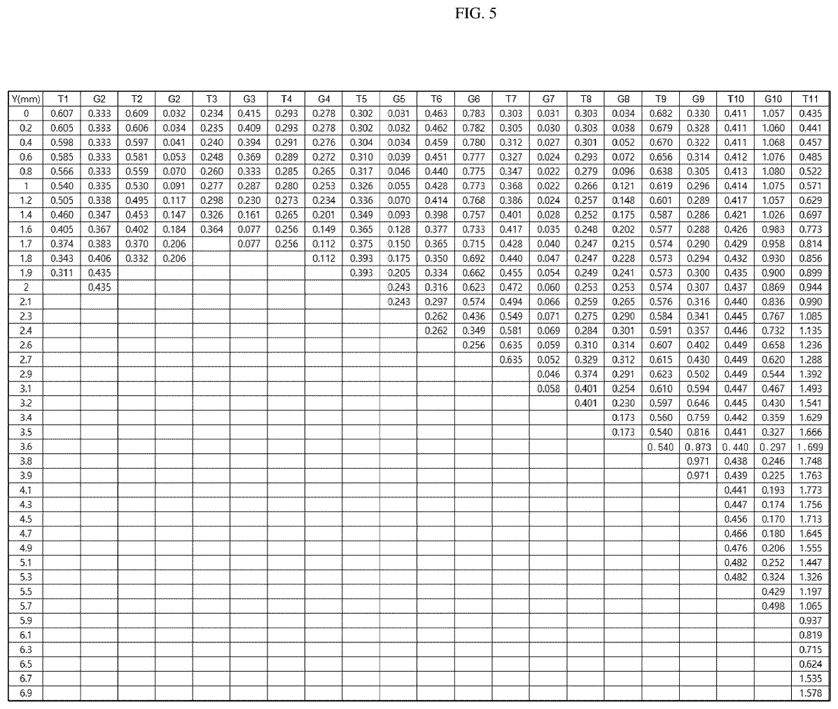

Also, as shown in FIG. 5, the thickness of each lens 101-111 may be defined as T1 to T11, and may be expressed at intervals of 0.1 mm or more from the center toward the edge in the first direction Y. The distance between two adjacent lenses may be expressed as G1 to G10, and may be expressed as a gap of 0.1 mm or more from the center between the two adjacent lenses toward the first direction Y.

The distance CG10 between the tenth and eleventh lenses 110 and 111 may be larger than the center distance CG3 between the third and fourth lenses 103 and 104, and may satisfy the following conditions.

$$( CG 3 * 2 ) < CG 10 \qquad Condition 1$$

$$( CT 10 + CT 11 ) < CG 10 \qquad Condition 2$$

The center thickness CT9 of the ninth lens 109 is the maximum among the center thicknesses of the lenses, and the center distance CG10 between the ninth lens 109 and the eleventh lens 111 is the maximum between the lenses. The center thickness CT3 of the third lens 103 is the smallest among the lenses, and the center thickness CT3 of the third lens 103 are the minimum among the lenses, and at least one of the center distance CG2 between the second and third lenses 102 and 103, the center distance CG7 between the seventh and eighth lenses 107 and 108, and the center distance CG8 between the eighth and ninth lenses 108 and 109 may be the minimum of the center distances between the lenses, and the minimum distance may be 0.1 mm or less. Accordingly, the optical system 1000 having 10 or more lenses may be provided in a slim size.

Among the plurality of lens surfaces S1-S22, the number of surfaces with an effective radius of less than 2 mm may be smaller than the number of surfaces with an effective radius of 2 mm or more, and the number of lenses with a center thickness of each lens of less than 0.4 mm may be less than 50%, for example, less than 50%.

When defining the focal length of each lens 101-111 as F1, F2, F3, F4, F5, F6, F7, F8, F9, F10, F11, in the absolute values, the following conditions may satisfy: F1<F3 and F3<F4<F5, and the condition may satisfy: F11<F8<F5<F10. By adjusting this focal length, resolution may be affected. When the focal length is described as an absolute value, the focal length F10 of the tenth lens 110 may be the largest among the lenses, the focal length of the eleventh lens 111 may be the minimum, and the focal length of the first and second lenses 101 and 102 may be the largest among the lenses, and a difference between the focal lengths may be 10 mm or less. The maximum focus length may be 100 times or more than the minimum focus length.

When the refractive index of each lens 101-108 is n1, n2, n3, n4, n5, n6, n7, n8, n9, n10, and n11, and the Abbe number of each lens 101-111 is v1, v2, v3, v4, v5, v6, v7, v8, v9, v10, and v11, the refractive index may satisfy the following condition: n1<n3, and n1, n2, n4, n6, n7, n8, n10, and n11 are less than 1.6 and may have a difference of 0.2 or less from each other, and n3, n5, n7, and n9 are greater than 1.60. Abbe number may satisfy the condition: v3<v1, and v1, v2, v8, v10, and v11 are 45 or more and may have a difference of 10 or less from each other. Accordingly, the optical system 1000 may have improved chromatic aberration control characteristics. Preferably, the condition may satisfy: v3*n3<v1*n1.

The optical system 1000 according to the embodiment disclosed above may satisfy at least one or two of the equations described below. Accordingly, the optical system 1000 according to the embodiment may have improved optical characteristics. For example, when the optical system 1000 satisfies at least one mathematical equation, the optical system 1000 may effectively control aberration characteristics such as chromatic aberration and distortion aberration, and may have good optical performance not only in the center portion but also in the periphery portion of the FOV. The optical system 1000 may have improved resolution and may have a slimmer and more compact structure.

Hereinafter, the center thickness of the first to eleventh lenses 101-111 may be defined as CT1 to CT11, the edge thickness may be defined as ET1 to ET11, and the center distance or optical axis distance between two adjacent lenses may be defined as CG1. to CG10, and the edge distance between two adjacent lenses may be defined as EG1 to EG10. The units of the thickness, distance, effective diameter, and curvature radius are mm.

$$1 < CT 3 / CT 1 < 6 \qquad [ Equation 1 ]$$

In Equation 1, when the thickness CT3 at the optical axis of the third lens 103 and the thickness CT1 at the optical axis of the first lens 101 are satisfied, the optical system 1000 may improve aberration characteristics. Preferably, Equation 1 may satisfy: 2<CT3/CT1<4.

$$0.3 < CT 3 / ET 3 < 2 \qquad [ Equation 2 ]$$

In Equation 2, when the center thickness CT3 and the edge thickness ET3 of the third lens 103 are satisfied, the optical system 1000 may have improved chromatic aberration control characteristics. Preferably, Equation 2 may satisfy: 0.3<CT3/ET3<1.

$$1 < CT 1 / ET 1 < 5 \qquad [ Equation 2 - 1 ]$$

$$1 < CT 2 / ET 2 < 5 \qquad [ Equation 2 - 2 ]$$

$$( CT 2 + CT 3 ) > CT 1 \qquad [ Equation 2 - 3 ]$$

$$0.8 < CT 4 / ET 4 < 2 \qquad [ Equation 2 - 4 ]$$

$$0.8 < CT 5 / ET 5 < 2 \qquad [ Equation 2 - 5 ]$$

$$1 < CT 6 / ET 6 < 5 \qquad [ Equation 2 - 6 ]$$

$$0.3 < CT 7 / ET 7 < 2 \qquad [ Equation 2 - 7 ]$$

$$0.5 < CT 8 / ET 8 < 2 \qquad [ Equation 2 - 8 ]$$

$$0 < CT 9 / ET 9 < 1 \qquad [ Equation 2 - 9 ]$$

$$0.8 < CT 10 / ET 10 < 2 \qquad [ Equation 2 - 10 ]$$

$$0.3 < CT 11 / ET 11 < 2 \qquad [ Equation 2 - 11 ]$$

$$CT 11 / ET 11 < CT 1 / ET 1 \qquad [ Equation 2 - 12 ]$$

$$0.5 < SD / TD < 1 \qquad [ Equation 2 - 13 ]$$

When the ratio between the center thickness and the edge thickness of the second to eleventh lenses 102-111 is satisfied in Equations 2-1 to 2-12, the optical system 1000 may have improved chromatic aberration control characteristics. In Equation 2-13, SD is the optical axis distance from the aperture stop ST to the sensor-side twenty-second surface S22 of the eleventh lens 111, and TD is the optical axis distance from the object-side first surface S1 of the first lens 101 to the sensor-side twenty-second surface S22 of the eleventh lens 111. The aperture stop ST may be disposed around the sensor-side surface of the second lens 102. When the optical system 1000 according to the embodiment satisfies Equation 2-13, the chromatic aberration of the optical system 1000 may be improved.

$$1 < \vert F\_LG 2 / F\_LG 1 \vert < 10 \qquad [ Equation 2 - 14 ]$$

F_LG1 is the composite focal length of the first lens group LG1, and F_LG2 is the composite focal length of the second lens group LG2. When the optical system 1000 according to the embodiment satisfies Equation 2-14, the chromatic aberration of the optical system 1000 may be improved. That is, as the value of Equation 2-14 approaches 1, the distortion aberration may be reduced. The value of Equation 2-14 may satisfy: 1<F_LG2/F_LG1|<3.

$$18 < TTL / CT\_Aver < 28 \qquad [ Equation 3 ]$$

In Equation 3, TTL is the optical axis distance from the center of the first surface S1 of the first lens 101 to the upper surface of the image sensor 300, and CT_Aver is the average of the center thicknesses of the first to eleventh lenses 101-111. When Equation 3 is satisfied, a slim optical system may be provided. Preferably, 18<TTL/CT_Aver<25 may be satisfied.

$$1.60 < n 3 \qquad [ Equation 4 ]$$

In Equation 4, n3 means the refractive index at the d-line of the third lens 103. When the optical system 1000 according to the embodiment satisfies Equation 4, the optical system 1000 may improve chromatic aberration characteristics. Preferably, 1.65≤n3 may be satisfied. Additionally, it may satisfy: 17<(n3*n) (where, n is the number of lenses).

$$1.5 < n 1 < 1.6 \qquad [ Equation 4 - 1 ]$$

$$1.5 < n 10 < 1.6$$

$$1.5 < n 11 < 1.6$$

$$16 < n 1 * n < 18$$

$$16 < n 10 * n < 18$$

$$16 < n 11 * n < 18$$

In Equation 4-1, n1 is the refractive index at the d-line of the first lens 101, n10 is the refractive index at the d-line of the tenth lens 110, and n11 is the refractive index of the eleventh lens 111 at the d-line, and n is the total number of lenses in the optical system. When the optical system 1000 according to the embodiment satisfies Equation 4-1, the influence on the TTL of the optical system 1000 may be suppressed.

$$17 < n 5 * n \qquad [ Equation 4 - 2 ]$$

$$17 < n 7 * n$$

In Equation 4-2, n5 is the refractive index at the d-line of the fifth lens 105, n7 is the refractive index at the d-line of the seventh lens 107, and n is the total number of lenses in the optical system. When the optical system 1000 according to the embodiment satisfies Equation 4-2, the optical system 1000 may improve chromatic aberration characteristics.

$$0 \text{.5} < Max\_Sag 112 to Sensor < 1.5 \qquad [ Equation 5 ]$$

In Equation 5, Max_Sag112 to Sensor means the distance in a direction of the optical axis from the maximum Sag value of the sensor-side twenty-second surface S22 of the eleventh lens 111 to the image sensor 300. Here, Sag112 is the optical axis distance from the straight line extending in the directions X and Y perpendicular to the center of the twenty-second surface S22 of the eleventh lens 111 to the twenty-second surface S22, and when the Sag112 value is positive, it may be a lens surface extending toward the sensor side beyond the straight line, and when it is a negative value, it may be a lens surface extending toward the object side beyond the straight line.

Max_Sag112 to Sensor means the distance in a direction of the optical axis from the critical point P1 of the sensor-side surface of the eleventh lens 111 to the image sensor 300. When the optical system 1000 according to the embodiment satisfies Equation 5, the optical system 1000 may secure a space where the optical filter 500 may be placed between the lens portion 100 and the image sensor 300, so it may have improved assemblability. Additionally, when the optical system 1000 satisfies Equation 5, the optical system 1000 may secure a gap for module manufacturing. Preferably, the value of Equation 5 may satisfy: 0.5<Max_Sag112 to Sensor<1.

In the lens data for the embodiment, the position of the filter 500, in detail, the distance between the last lens and the filter 500, and the distance between the image sensor 300 and the filter 500 are set for convenience in the design of the optical system 1000, and the filter 500 may be freely disposed within a range in which the last lens and the image sensor 300 do not come into contact. Accordingly, the value of Max_Sag112 to Sensor in the lens data may be smaller than the BFL (Back focal length) of the optical system 1000, and the position of the filter 500 may move within a range that is not in contact with the last lens and the image sensor 300, respectively, to have good optical performance. That is, the twenty-second surface S22 of the eleventh lens 111 has the minimum distance between the critical point P1 and the image sensor 300, and |Sag112| may gradually increase from the critical point P1 toward the end of the effective region.

$$1 < BFL / Max\_Sag 112 to Sensor < 2 \qquad [ Equation 6 ]$$

In Equation 6, the BFL means a distance (unit: mm) in the optical axis OA from the center of the sensor-side twenty-second surface S22 of the eleventh lens 111 closest to the image sensor 300 to the upper surface of the image sensor 300. When the optical system 1000 according to the embodiment satisfies Equation 6, the optical system 1000 may improve distortion aberration characteristics and have good optical performance in the peripheral portion of the FOV. Here, the maximum Sag value may be the critical point position. Equation 6 may satisfy: 1<BFL/Max_sag112 to Sensor<1.5.

$$5 < \vert Max slope 112 \vert < 45 \qquad [ Equation 7 ]$$

In Equation 7, Max slope112 means the maximum value (Degree) of the tangential angle measured on the sensor-side twenty-second surface S22 of the eleventh lens 111. In detail, Max slope112 on the twenty-second surface S22 means the angle value (Degree) of the point having the largest tangent angle with respect to an imaginary line extending in a direction perpendicular to the optical axis OA. When the optical system 1000 according to the embodiment satisfies Equation 7, the optical system 1000 may control the occurrence of lens flare. Preferably, Equation 7 may satisfy: 25≤|Max slope112|≤45. |Max Slope112| may mean the maximum angle of the first angle in FIG. 2.

$$CT 9 < \vert Max Sag 112 \vert \qquad [ Equation 8 ]$$

In Equation 8, Max_Sag112 is the maximum distance from the straight line extending in the directions X and Y perpendicular to the center of the sensor-side surface of the eleventh lens 111 to the twelfth surface S12, and CT9 is the center thickness of the ninth lens 109. When Equation 8 is satisfied, the optical system 1000 may have a height greater at the outer portion of the effective region of the sensor-side surface of the eleventh lens 111 compared to the center thickness of the ninth lens 109, which has the maximum center thickness. Accordingly, the eleventh lens 111 has a maximum effective diameter Sag112 and can refract the incident light toward the image sensor 300. When the optical system 1000 according to the embodiment satisfies Equation 8, the size of the image sensor 300 may be increased compared to the TTL of the optical system 1000, and a slim optical system may be provided. Preferably, the condition may satisfy: 1<|Max_Sag112|<1.7.

$$CG 6 < \vert Max\_Sag 102 \vert < ( CG 6 * 2 ) \qquad [ Equation 9 ]$$

In Equation 9, CG6 is the optical axis distance between the sixth lens 106 and the seventh lens 107, and |Max_Sag102| is the maximum separation distance from the straight line extending in a direction perpendicular to the center of the sensor-side surface of the tenth lens 110 to the twentieth surface S20. When the optical system satisfies Equation 9, the optical system 1000 may improve distortion aberration characteristics and have good optical performance in the peripheral portion of the FOV. Preferably, the condition may satisfy: CT9<CG6<CG10.

$$1 < CG 10 / EG 10 < 5 \qquad [ Equation 10 ]$$

In Equation 10, when the optical axis distance CG10 and the edge distance EG10 between the tenth and eleventh lenses 110 and 111 are satisfied, good optical performance may be achieved even in the center and periphery portions of the FOV. Additionally, the optical system 1000 may reduce distortion and thus have improved optical performance. Preferably, Equation 10 may satisfy: 1.5<CG10/EG10<3.

$$0 < CG 10 / CG 6 < 2 \qquad [ Equation 11 ]$$

In Equation 11, when the optical axis distance CG6 between the sixth and seventh lenses 106 and 107 and the optical axis distance CG10 between the tenth and eleventh lenses 110 and 111 are satisfied, the optical system 1000 may improve aberration characteristics and control the size of the optical system 1000, for example, TTL. Preferably, Equation 11 may satisfy: 1<CG10/CG6<2, or 11<(CG10/CG6)*n<22, where n is the number of lenses.

$$5 < CA 112 / CG 10 < 20 \qquad [ Equation 11 - 1 ]$$

In Equation 11-1, CA112 is the effective diameter of the largest lens surface, and is the effective diameter of the sensor-side twenty-second surface S22 of the eleventh lens 111. When the optical system 1000 according to the embodiment satisfies Equation 11-1, the optical system 1000 may improve aberration characteristics and control TTL reduction. Preferably, Equation 11-1 may satisfy:

$$10 < CA 112 / CG 10 < 15. \qquad [ Equation 11 - 2 ]$$

$$8 < CA 10 \; 2 / CG 10 < 15$$

Equation 11-2 may set the effective diameter CA102 of the sensor-side twentieth surface S20 of the tenth lens 110 and the optical axis distance CG10 between the tenth and eleventh lenses 110 and 111. When the optical system 1000 according to the embodiment satisfies Equation 11-2, the optical system 1000 may improve aberration characteristics and control TTL reduction. Preferably, Equation 11-2 may satisfy: 8<CA102/CG10<12.

$$0 < CT 1 / CT 11 < 3 \qquad [ Equation 12 ]$$

In Equation 12, when the thickness CT1 at the optical axis of the first lens 101 and the thickness CT11 at the optical axis of the eleventh lens 111 are satisfied, the optical system 1000 may have improved aberration characteristics. The optical system 1000 has good optical performance at a set FOV and may control TTL. Preferably, Equation 12 may satisfy: 1<CT1/CT11<2, or 11<(CT1/CT11)*n<22, where n is the number of lenses.

$$0 < CT 10 / CT 11 < 2 \qquad [ Equation 13 ]$$

In Equation 13, when the thickness CT10 at the optical axis of the tenth lens 110 and the thickness CT11 at the optical axis of the eleventh lens 111 are satisfied, the optical system 1000 determines the tenth lens 110 and manufacturing precision of the eleventh lens 111 may be alleviated, and optical performance of the center and periphery portions of the FOV may be improved. Preferably, Equation 13 may satisfy: 0.5<CT10/CT11<1.5, or 5.5<(CT10/CT11)*n<16.5, where n is the number of lenses. The center thickness of the seventh, eighth, and ninth lenses may satisfy the following condition: (CT7+CT8)<CT9. Additionally, the center thickness of the first, second, third, and eighth lenses may satisfy the following condition: (CT3+CT4+CT5)<(CT1+CT2).

$$0 < \vert L 10 R 2 / L 11 R 1 \vert < 20 \qquad [ Equation 14 ]$$

In Equation 14, L10R2 means the curvature radius (unit: mm) on the optical axis of the twentieth surface S20 of the tenth lens 110, and L11R1 means the curvature radius (unit: mm) of the twenty-first surface S21 of the eleventh lens 111 on the optical axis. When the optical system 1000 according to the embodiment satisfies Equation 14, the aberration characteristics of the optical system 1000 may be improved. Preferably, Equation 14 may satisfy 1<|L10R2/L11R1|<5.

$$0 < ( CG 10 - EG 10 ) / CG 10 < 1 \qquad [ Equation 15 ]$$

When Equation 15 satisfies the center distance CG10 and edge distance EG10 between the tenth and eleventh lenses 110 and 111, the optical system 1000 may reduce the occurrence of aberration distortion and have improved optical performance. When the optical system 1000 according to the embodiment satisfies Equation 15, optical performance in the center and peripheral portions of the FOV may be improved. Equation 15 may preferably satisfy: 0<(CG10−EG10)/CG10<0.55. Here, when comparing the center distance between the fourth, fifth, sixth, seventh, and eighth lenses, the following condition may satisfy: CG4<CG5<CG6.

$$0 < CA 11 / CA 31 < 2 \qquad [ Equation 16 ]$$

In Equation 16, CA11 means the effective diameter (Clear aperture: CA) of the first surface S1 of the first lens 101, and CA31 means the effective diameter (CA) of the fifth surface S5 of the third lens 103. When the optical system 1000 according to the embodiment satisfies Equation 16, the optical system 1000 may control light incident on the first lens group LG1 and have improved aberration control characteristics. Equation 16 preferably satisfies: 1≤CA11/CA31≤1.5 or 11≤(CA11/CA31)*n≤16.5, where n is the number of lenses.

$$1 < CA 112 / CA 42 < 6 \qquad [ Equation 17 ]$$

In Equation 17, CA42 means the effective diameter of the eighth surface S8 of the fourth lens 104, and CA112 means the effective diameter of the twenty-second surface S22 of the eleventh lens 111. When the optical system 1000 according to the embodiment satisfies Equation 17, the optical system 1000 may control light incident on the second lens group LG2 and improve aberration characteristics. Preferably, Equation 17 may satisfy: 2<CA112/CA42<5, or 22<(CA112/CA42)*n<55, where n is the number of lenses.

$$0.5 < CA 42 / CA 32 < 1.5 \qquad [ Equation 18 ]$$

In Equation 18, when the effective diameter CA32 of the sixth surface S6 of the third lens 103 and the effective diameter CA42 of the eighth surface S8 of the fourth lens 104 are satisfied, the optical system 1000 may improve chromatic aberration by controlling the optical path between the first and second lens groups LG1 and LG2 and control vignetting for optical performance. Preferably, Equation 18 may satisfy: 0.8<CA42/CA32<1.2, or 8.8<(CA42/CA32)*n<13.2, where n is the number of lenses.

$$0.1 < CA 52 / CA 102 < 1 \qquad [ Equation 19 ]$$

In Equation 19, when the effective diameter CA52 of the tenth surface S10 of the fifth lens 105 and the effective diameter CA102 of the twentieth surface S20 of the tenth lens 110 are satisfied, the optical system 1000 may improve chromatic aberration by controlling the light path on the exit side. Preferably, Equation 19 may satisfy: 0.1<CA52/CA102<0.5, or 1.1<(CA52/CA102)*2<6.5, where n is the number of lenses.

$$1 < CA 112 / CA 11 < 5 \qquad [ Equation 20 ]$$

In Equation 20, when the effective diameter CA11 of the first surface S1 of the first lens 101 and the effective diameter CA112 of the twenty-second surface S22 of the eleventh lens 111 are satisfied, the optical system 1000 may improve chromatic aberration by controlling the light path on the exit side. Preferably, Equation 20 may satisfy: 2<CA52/CA102<4, or 22<(CA52/CA102)*2<44, where n is the number of lenses.

$$1 < CG 3 / EG 3 < 10 \qquad [ Equation 21 ]$$

In Equation 20, when the center distance CG3 between the third and fourth lenses 103 and 104 in the optical axis and the edge distance EG3 between the third and fourth lenses 103 and 104 are satisfied, the optical system 1000 may reduce chromatic aberration, improve aberration properties, and control vignetting for optical performance. Preferably, Equation 20 may satisfy: 4<CG3/EG3<9.

$$0 < CG 9 / EG 9 < 1 \qquad [ Equation 22 ]$$

In Equation 22, when the center distance CG9 and edge distance EG9 between the ninth and tenth lenses 109 and 110 are satisfied, the optical system may have good optical performance even in the center and periphery portions of the FOV, and may suppress the occurrence of distortion. Preferably, 0.3<CG9/EG9<0.8 may be satisfied. At least one of Equations 21 and 22 may further include at least one of Equations 22-1 to 22-7.

$$0 < CG 1 / EG 1 < 1.5 \qquad [ Equation 22 - 1 ]$$

$$0 < CG 2 / EG 2 < 0.5 \qquad [ Equation 22 - 2 ]$$

$$3 < CG 4 / EG 4 < 8 \qquad [ Equation 22 - 3 ]$$

$$0 < CG 5 / EG 5 < 0.5 \qquad [ Equation 22 - 4 ]$$

$$3 < CG 6 / EG 6 < 15 \qquad [ Equation 22 - 5 ]$$

$$0 < CG 7 / EG 7 < 1.5 \qquad [ Equation 22 - 6 ]$$

$$0 < CG 8 / EG 8 < 1 \qquad [ Equation 22 - 6 ]$$

Light traveling through the center and edge portions between two adjacent lenses may be guided to the center and edge portions of the last lens by the above-mentioned center distance and edge distance.

$$0 < G10\_Max / CG 10 < 2 \qquad [ Equation 23 ]$$

In Equation 23, when the center distance CG10 and the maximum distance G10_Max among the distances between the tenth and eleventh lenses 110 and 111 are satisfied, the optical system 1000 may improve optical performance in the periphery portion of the FOV and may suppress distortion of aberration characteristics. Preferably, Equation 22 may satisfy: 0.5<G10_Max/CG10<1.5.

$$0 < CT 9 / CG 10 < 1 \qquad [ Equation 24 ]$$

In Equation 24, when the thickness CT9 at the optical axis of the ninth lens 109 and the gap CG10 between the tenth and eleventh lenses 110 and 111 on the optical axis are satisfied, the optical system 1000 may reduce the effective diameter of the ninth and tenth lenses and the center distances between adjacent lenses, and may improve the optical performance of the periphery portion of the FOV. Preferably, Equation 24 may satisfy: 0.4<CT9/CG10<0.8, or 4.4<(CT9/CG10)*n<8.8, where n is the total number of lenses.

$$1 < CG 10 / CT 10 < 5 \qquad [ Equation 25 ]$$

In Equation 25, when the thickness CT10 at the optical axis of the tenth lens 110 and the gap CG10 between the tenth and eleventh lenses 110 and 111 are satisfied, the optical system 1000 may reduce the effective diameter of the ninth and tenth lenses and the center distances, and may improve the optical performance of the periphery portion of the FOV. Preferably, Equation 25 may satisfy: 2<CG10/CT10<3.

$$1 < CG 10 < CT 11 < 4 \qquad [ Equation 26 ]$$

In Equation 26, when the thickness CT11 at the optical axis of the eleventh lens 111 and the gap CG10 between the tenth and eleventh lenses 110 and 111 are satisfied, the optical system 1000 may reduce the effective diameter of the ninth and tenth lenses and the center distances, and may improve the optical performance of the periphery portion of the FOV. Preferably, Equation 26 may satisfy: 2<CG10/CT11<3.

$$1 < \vert L 5 R 2 / CT 5 \vert < 100 \qquad [ Equation 27 ]$$

In Equation 27, when the curvature radius L5R2 of the tenth surface S10 of the fifth lens and the thickness CT5 at the optical axis of the fifth lens are satisfied, the optical system 1000 controls a lens shape and refractive power of the fifth lens, and may improve optical performance. Preferably, Equation 27 may satisfy: 40<|L5R2/CT5|<80.

$$0 < L 5 R 1 / L 11 R 1 < 10 \qquad [ Equation 28 ]$$

If Equation 28 satisfies the curvature radius L5R1 of the ninth surface S9 of the fifth lens and the curvature radius L11R1 of the twenty-first surface S21 of the eleventh lens, optical performance may be improved by controlling the shape and refractive power of the fifth and eleventh lenses, and also the output-side optical performance of the second lens group LG2 may be improved. Preferably, Equation 28 may satisfy: 1<L5R1/L11R1<3.

$$0 < L 1 R 1 / L 1 R 2 < 1 \qquad [ Equation 29 ]$$

Equation 29 may set the curvature radii L1R1 and L1R2 of the object-side first surface S1 and second surface S2 of the first lens 101, and when these are satisfied, the lens size and resolution may be set. Preferably, Equation 29 may satisfy: 0.3<L1R1/L1R2<0.8. Preferably, it may satisfy: L1R1>0 and L1R2>0.

$$0 < L 2 R 2 / L 2 R 1 < 1 \qquad [ Equation 30 ]$$

Equation 30 may set the curvature radii L2R1 and L2R2 of the object-side third surface S3 and fourth surface S4 of the second lens 102, and when these are satisfied, the resolution of the lens may be determined. Preferably, Equation 30 may satisfy: 0<L2R2/L2R1<0.6. Preferably, L2R1>0 and L2R2>0 may be satisfied. At least one of Equations 28, 29, and 30 may include at least one of Equations 30-1 to 30-11 below, and the resolution of each lens may be determined.

$$1 < L 3 R 1 / L 3 R 2 < 2 \qquad [ Equation 30 - 1 ]$$

$$5 < \vert L 4 R 1 / L 4 R 2 \vert < 20 \qquad [ Equation 30 - 2 ]$$

$$0.5 < L 5 R 1 / L 5 R 2 < 2 \qquad [ Equation 30 - 3 ]$$

$$0.5 < L 6 R 1 / L 6 R 2 < 4 \qquad [ Equation 30 - 4 ]$$

$$0 < \vert L 7 R 1 / L 7 R 2 \vert < 0.5 \qquad [ Equation 30 - 5 ]$$

$$0 < L 8 R 1 / L 8 R 2 < 1.5 \qquad [ Equation 30 - 6 ]$$

$$0 < L 9 R 1 / L 9 R 2 < 1 \qquad [ Equation 30 - 7 ]$$

$$0 < L 10 R 1 / L 10 R 2 < 2 \qquad [ Equation 30 - 8 ]$$

$$1 < L 11 R 1 / L 11 R 2 < 10 \qquad [ Equation 30 - 9 ]$$

Equations 30-1 to 30-9 may set the curvature radii R1 and R2 of the object-side surface and the sensor-side surface of each lens, and when these are satisfied, the size and resolution of each lens may be determined.

$$0 < CT\_Max / CG\_Max < 2 \qquad [ Equation 31 ]$$

In Equation 31, when the maximum thickness CT_Max at the optical axis OA of each of the lenses and the maximum distance CG_Max between the plurality of lenses are satisfied, the optical system 1000 has good optical performance at the set FOV and focal length, and the size of the optical system 1000, for example TTL may be reduced. Preferably, Equation 31 may satisfy: 0<CT_Max/CG_Max<1, or 4<(CT_Max/CG_Max)*n<11, where n is the number of lenses. Additionally, it may satisfy: CT_Max*n>6, and CG_Max*n>8.

$$1 < \sum CT / \sum CG < 2.5 \qquad [ Equation 32 ]$$

In Equation 32, ΣCT means the sum of the thicknesses (unit: mm) at the optical axis OA of each of the plurality of lenses, and ΣCG means the sum of the distances (unit: mm) in the optical axis OA between two adjacent lenses in the plurality of lenses. When the optical system 1000 according to the embodiment satisfies Equation 32, the optical system 1000 has good optical performance at the set FOV and focal length, and may reduce the size of the optical system 1000, for example, TTL. Preferably, Equation 32 may satisfy: 1<ΣCT/ΣCG<1.8. Additionally, the following condition may satisfy: 11<(ΣCT/ΣCG)*n<19.8, where n is the number of lenses. The following conditions may satisfy: ΣCT*n>45, and ΣCG*n>30.

$$10 < \sum Index < 30 \qquad [ Equation 33 ]$$

In Equation 33, ΣIndex means the sum of the refractive indices at the d-line of each of the plurality of lenses. When the optical system 1000 according to the embodiment satisfies Equation 33, TTL of the optical system 1000 may be controlled and resolution may be improved. Here, the average refractive index of the first to eleventh lenses may be 1.55 or more. Preferably, Equation 33 may satisfy: 15<ΣIndex<20, or 165<(ΣIndex)*n<220, where n is the number of lenses.

$$10 < \sum Abb / \sum Index < 50 \qquad [ Equation 34 ]$$

In Equation 34, ΣAbbe means the sum of Abbe numbers of each of the plurality of lenses. When the optical system 1000 according to the embodiment satisfies Equation 34, the optical system 1000 may have improved aberration characteristics and resolution. The average Abbe number of the first to eleven lenses may be 50 or less, for example, 45 or less. Preferably, Equation 34 may satisfy: 20<ΣAbb/ΣIndex<30, or 220<(ΣAbb/ΣIndex)*n<330, where n is the number of lenses.

$$0 < \vert Max\_distortion \vert < 5 \qquad [ Equation 35 ]$$

In Equation 35, Max_distortion means the maximum value of distortion in the region from the center (0.0 F) to the diagonal end (1.0 F) based on the optical characteristics detected by the image sensor 300. When the optical system 1000 according to the embodiment satisfies Equation 35, the optical system 1000 may improve distortion characteristics. Preferably, Equation 35 may satisfy: 1<|Max_distortion|<3.

$$0 < EG\_Max / CT\_Max < 3 \qquad [ Equation 36 ]$$

In Equation 36, CT_Max means to the thickest thickness (unit: mm) among the thicknesses at the optical axis OA of each of the plurality of lenses, and EG_Max is the maximum edge-side distance between two adjacent lenses. When the optical system 1000 according to the embodiment satisfies Equation 36, the optical system 1000 has a set FOV and focal length, and may have good optical performance in the periphery portion of the FOV. Preferably, Equation 36 may satisfy: 0.5<EG_Max/CT_Max<1.5.

$$0.5 < CA 11 / CA\_Min < 2 \qquad [ Equation 37 ]$$

In Equation 37, when the effective diameters CA11 of the first surface of the first lens and the smallest effective diameter CA_Min among the effective diameters of the first to twenty-second surfaces S1-S22 is satisfied, it is possible to control light incident through the first lens and provide a slim optical system while controlling light to be emitted and maintaining optical performance. Preferably, Equation 37 may satisfy: 1<CA11/CA_Min<1.5.

$$1 < CA\_Max / CA\_Min < 7 \qquad [ Equation 38 ]$$

In Equation 38, CA_Max means the largest effective diameter among the object-side surface and the sensor-side surface of the plurality of lenses, and means the largest effective diameter (unit: mm) of the first to twenty-second surfaces S1-S22. When the optical system 1000 according to the embodiment satisfies Equation 38, the optical system 1000 may provide a slim and compact optical system while maintaining optical performance. Preferably, Equation 38 may satisfy: 3<CA_Max/CA_Min<5.

$$1 < CA\_Max / CA\_Aver < 4 \qquad [ Equation 39 ]$$

In Equation 39, the maximum effective diameter CA_Max and the average effective diameter CA_Aver are set among the object-side surface and the sensor-side surface of the plurality of lenses. When these are satisfied, a slim and compact optical system may be provided. Preferably, Equation 39 may satisfy: 1.5<CA_Max/CA_AVR<3.

$$0. 1 < CA\_Min / CA\_Aver < 1 \qquad [ Equation 40 ]$$

In Equation 40, the smallest effective diameter CA_Min and average effective diameter CA_Aver may be set among the object-side surface and sensor-side surface of the plurality of lenses, and when these are satisfied, a slim and compact optical system may be provided. Preferably, Equation 38 may satisfy: 0.1<CA_Min/CA_Aver<0.8.

$$0.1 < CA\_Max / ( 2 * Imgh ) < 1.5 \qquad [ Equation 41 ]$$

In Equation 41, the largest effective diameter CA_Max among the object-side surfaces and the sensor-side surfaces of the plurality of lenses and the distance Imgh from the center (0.0 F) of the image sensor 300 overlapping the optical axis OA of the image sensor 300 to the diagonal end (1.0 F) may be set, and when this is satisfied, the optical system 1000 may have good optical performance in the center and periphery portions of the FOV and provide a slim and compact optical system. Here, Imgh*n may range from 44 mm to 110 mm, and n is the number of lenses. Preferably, Equation 41 may satisfy: 0.5<CA_Max/(2*Imgh)<1.

$$0.1 < TD / CA\_Max < 1.5 \qquad [ Equation 42 ]$$

In Equation 42, TD is the maximum optical axis distance (unit: mm) from the object-side surface of the first lens to the sensor-side surface of the last lens. For example, TD is the distance from the first surface S1 of the first lens 101 to the twenty-second surface S22 of the eleventh lens 111 in the optical axis OA. When the optical system 1000 according to the embodiment satisfies Equation 42, a slim and compact optical system may be provided. Preferably, Equation 42 may satisfy: 0.3<TD/CA_Max<1.

$$0 < F / L 11 R 2 < 5 \qquad [ Equation 43 ]$$

In Equation 43, the total effective focal length F of the optical system 1000 and the curvature radius L11R2 of the twenty-second surface of the eleventh lens may be set, and when these are satisfied, a size of the optical system 1000, for example, the TTL may be reduced. Preferably, Equation 43 may satisfy: 1<F/L11R2<5.

Equation 43 may further include Equation 43-1 below.

$$1 < F / F \# < 6 \qquad [ Equation 43 - 1 ]$$

The F # may mean the F number. Preferably, Equation 43-1 may satisfy: 2<F/F #<5.

$$0 < F / L 11 R 2 < 1 \qquad [ Equation 43 - 2 ]$$

Equation 43-2 may set the total effective focal length F of the optical system 1000 and the curvature radius L11R2 of the twenty-second surface of the eleventh lens. Preferably, Equation 43-2 may satisfy: 0<F/L11R2<0.5.

$$1 < F / L 1 R 1 < 10 \qquad [ Equation 44 ]$$

In Equation 44, the curvature radius L1R1 and the total effective focal length F of the first surface S1 of the first lens 101 may be set, and when these are satisfied, the optical system 1000 may be reduced in size, for example, reducing TTL. Preferably, Equation 44 may satisfy: 1<F/L1R1<5.

$$0 < EPD / L 11 R 2 < 5 \qquad [ Equation 45 ]$$

In Equation 45, EPD means the entrance pupil diameter (mm) of the optical system 1000, and L11R2 means the curvature radius (mm) of the twenty-second surface S22 of the eleventh lens 111. When the optical system 1000 according to the embodiment satisfies Equation 45, the optical system 1000 may control overall brightness and may have good optical performance in the center and periphery portions of the FOV. Preferably, Equation 45 may satisfy: 1<EPD/L11R2<2. Equation 45 may further include Equation 45-1 below.

$$1 < EPD / F \# < 3 \qquad [ Equation 45 - 1 ]$$

$$0.5 < EPD / L 1 R 1 < 8 \qquad [ Equation 46 ]$$

Equation 46 represents the relationship between the entrance pupil diameter of the optical system and the curvature radius of the first surface S1 of the first lens 101, and may control incident light. Preferably, Equation 46 may satisfy: 0.5<EPD/L1R1<2.

$$0 < \vert F 1 / F 3 \vert < 2 \qquad [ Equation 47 ]$$

In Equation 47, the focal distances F1 and F3 of the first and third lenses 101 and 103 may be set. Accordingly, resolving power may be improved by adjusting the refractive power of the incident light of the first and second lenses 101 and 102, and TTL may be controlled. Preferably, Equation 47 may satisfy: −2<F1/F3<−0.8.

$$0 < F 13 / F < 5 \qquad [ Equation 48 ]$$

In Equation 48, when the composite focal length F13 of the first to third lenses and the total focal length F may set, the optical system 1000 may improve resolving power by adjusting the refractive power of incident light, and the optical system 1000 may control the TTL. Preferably, Equation 48 may satisfy: 0.5<F13/F<1.6.

$$0 < \vert F 411 / F 13 \vert < 4 \qquad [ Equation 49 ]$$

In Equation 49, the composite focal length F13 of the first to third lenses, that is, the focal length mm of the first lens group, and the composite focal length F411 of the fourth to eleventh lenses, that is, the focal length of the second lens group may be set, and when this is satisfied, resolving power may be improved by controlling the refractive power of the first lens group and the refractive power of the second lens group, and the optical system may be provided in a slim and compact size. In addition, when Equation 49 is satisfied, the optical system 1000 may improve aberration characteristics such as chromatic aberration and distortion aberration. Equation 49 may preferably satisfy: 1<|F411/F13|<3. Here, F13>0 and F411<0.

$$1 < F 1 / F < 4 \qquad [ Equation 50 ]$$

In Equation 50, the total focal length F and the focal length of the first lens 101 may be set, and resolution may be improved. Equation 50 may satisfy: 1<F1/F<3, and satisfies the conditions:

$$1 < F 1 / F 13 < 3 \qquad [ Equation 50 - 1 ]$$

$$1 < F 2 / F < 3.5 \qquad [ Equation 50 - 2 ]$$

$$- 7 < F 3 / F < 0 \qquad [ Equation 50 - 3 ]$$

$$5 < F 4 / F < 15 \qquad [ Equation 50 - 4 ]$$

$$50 < \vert F 5 \vert / F < 500 \qquad [ Equation 50 - 5 ]$$

$$1 < F 6 / F < 20 \qquad [ Equation 50 - 6 ]$$

$$- 5 < F 7 / F < 0 \qquad [ Equation 50 - 7 ]$$

$$- 50 < F 8 / F < - 5 \qquad [ Equation 50 - 8 ]$$

$$200 < F 10 / F \qquad [ Equation 50 - 9 ]$$

$$- 2 < F 11 / F < 0 \qquad [ Equation 50 - 10 ]$$

$$- 5 < F 3 / F 2 < 0 \qquad [ Equation 50 - 11 ]$$

The focal lengths F1-F11 and total focal length F of each lens may be set in equations 50-1 to 50-11, and when these are satisfied, the refractive power of each lens may be controlled to improve resolution, the optical system may be provided in a slim and compact size.

$$1 < F 4 / F 13 < 20 \qquad [ Equation 51 ]$$

In Equation 51, the resolution of the first and second lens groups may be adjusted by setting the focal length F4 of the fourth lens and the composite focal length F13 of the first and third lenses. Preferably, Equation 51 may satisfy: 5<F4/F13<15.

$$0 < \vert F 1 / F 411 \vert < 2 \qquad [ Equation 52 ]$$

in Equation 52, when the focal length F1 of the first lens and the composite focal length F411 of the fourth to eleventh lenses may be set, the size and resolution of the optical system may be adjusted. Preferably, Equation 52 may satisfy: 0.5<|F1/F411|<1.

$$0 < F 1 / F 4 < 1 \qquad [ Equation 53 ]$$

in Equation 53, when the focal length F1 of the first lens and the focal length F4 of the fourth lens may be set, the refractive power of light incident on the first and second lens groups may be controlled, and the size and resolution of the optical system may be adjusted. Preferably, Equation 53 may satisfy: 0<F1/F4<0.5.

$$2 mm < TTL < 20 mm \qquad [ Equation 54 ]$$

In Equation 54, TTL means the distance (unit: mm) in the optical axis OA from the apex of the first surface S1 of the first lens 101 to the upper surface of the image sensor 300. Preferably, Equation 54 may satisfy: 5<TTL<15 or 55<TTL*n<150, where n is the number of lenses. Accordingly, a slim and compact optical system may be provided.

$$2 mm < Imgh \qquad [ Equation 55 ]$$

Equation 55 sets the diagonal size (2*Imgh) of the image sensor 300 to exceed 4 mm, thereby providing an optical system with high resolution. Equation 55 preferably satisfies: 4<Imgh<12 or 44<Imgh*n<132, where n is the number of lenses.

$$BFL < 2.5 mm \qquad [ Equation 56 ]$$

Equation 56 may secure an installation space of the filter 500 by making the BFL of less than 2.5 mm, improve assembly of components, and improve coupling reliability through the distance between the image sensor 300 and the last lens. Equation 56 may preferably satisfy: 0.8<BFL<1.5.

$$2 mm < F < 20 mm \qquad [ Equation 57 ]$$

In Equation 57, the total focal length F may be set according to the optical system, and preferably satisfies: 5<F<15 or 55<F*n<165, where n is the number of lenses.

$$FOV < 120 degrees \qquad [ Equation 58 ]$$

In Equation 58, FOV means to the FOV (Degree) of the optical system 1000, and may provide an optical system of less than 120 degrees. The FOV may be 70 degrees or more, for example, in the range of 70 degrees to 111 degrees.

$$0 \text{.5} < TTL / CA\_Max < 2 \qquad [ Equation 59 ]$$

In Equation 59, a slim and compact optical system may be provided by setting the largest effective diameter CA_Max among the object side and sensor side of the plurality of lenses and TTL. Preferably, Equation 59 may satisfy: 0.5<TTL/CA_Max<1.

$$0 \text{.5} < TTL / Imgh < 3 \qquad [ Equation 60 ]$$

Equation 60 may set the TTL of the optical system and the diagonal length (Imgh) from the optical axis of the image sensor 300. When the optical system 1000 according to the embodiment satisfies Equation 60, the optical system 1000 may have a smaller TTL by securing a BFL for applying a relatively large image sensor 300, for example, a large image sensor 300 of around 1 inch, and may have a high-definition implementation and a slim structure. Preferably, Equation 60 may satisfy: 0.8<TTL/Imgh<2, and the equation multiplied by the total number (n) of lenses may satisfy: 8.8<(TTL/Imgh)*n<22. Within the specification, the symbol * represents multiplication.

$$0.01 < BFL / Imgh < 0.5 \qquad [ Equation 61 ]$$

Equation 61 may set the optical axis distance between the image sensor 300 and the last lens and the diagonal length from the optical axis of the image sensor 300. When the optical system 1000 according to the embodiment satisfies Equation 61, the optical system 1000 may secure a BFL for applying a relatively large image sensor 300, for example, a large image sensor 300 of around 1 inch, and minimize the distance between the last lens and the image sensor 300, thereby having good optical characteristics at the center and periphery portion of the FOV. Preferably, Equation 61 may satisfy:

$$0.05 < BFL / Imgh < 0.3.5 < TTL / BFL < 15 \qquad [ Equation 62 ]$$

Equation 62 may set (unit, mm) the total optical axis length TTL of the optical system and the optical axis distance (BFL) between the image sensor 300 and the last lens. When the optical system 1000 according to the embodiment satisfies Equation 62, the optical system 1000 secures BFL and may be provided in a slim and compact manner. Equation 62 may satisfy: 6<TTL/BFL<10. Additionally, the equation multiplied by the total number of lenses may satisfy: 66<(TTL/BFL)*n<110.

$$0.5 < F / TTL < 1.5 \qquad [ Equation 63 ]$$

Equation 59 may set the total focal length F and total optical axis length TTL of the optical system 1000. Accordingly, a slim and compact optical system may be provided. Equation 65 may preferably satisfy: 0.5<F/TTL<1.2.

$$0 < F \# / TTL < 0.5 \qquad [ Equation 63 - 1 ]$$

Equation 63-1 may set the F number (F #) and total optical axis length TTL of the optical system 1000. Accordingly, a slim and compact optical system may be provided.

$$3 < F / BFL < 10 \qquad [ Equation 64 ]$$

Equation 64 may set (unit, mm) the total focal length F of the optical system 1000 and the optical axis distance (BFL) between the image sensor 300 and the last lens. When the optical system 1000 according to the embodiment satisfies Equation 64, the optical system 1000 may have a set FOV and an appropriate focal length, and a slim and compact optical system may be provided. Additionally, the optical system 1000 may minimize the gap between the last lens and the image sensor 300 and thus have good optical characteristics in the peripheral portion of the FOV. Preferably, Equation 64 may satisfy: 5<F/BFL<9.

$$0 < F / Imgh < 3 \qquad [ Equation 65 ]$$

Equation 65 may set the total focal length F (unit: mm) of the optical system 1000 and the diagonal length (Imgh) from the optical axis of the image sensor 300. This optical system 1000 uses a relatively large image sensor 300, for example, around 1 inch, and may have improved aberration characteristics. Preferably, Equation 65 may satisfy: 0.5<F/Imgh<1.5.

$$1 < F / EPD < 5 \qquad [ Equation 66 ]$$

Equation 66 may set the total focal length F (unit: mm) and entrance pupil diameter of the optical system 1000. Accordingly, the overall brightness of the optical system may be controlled. Preferably, Equation 66 may satisfy: 1.5<F/EPD<3.

$$0 < BFL / TD < 0.5 \qquad [ Equation 67 ]$$

In Equation 67, the optical axis distance (BFL) between the image sensor 300 and the last lens and the optical axis distance (TD) of the lenses are set. When this is satisfied, the optical system 1000 may provide a slim and compact optical system. Preferably, Equation 67 may satisfy: 0<BFL/TD<0.2. If BFL/TD exceeds 0.2, the size of the entire optical system increases because the BFL compared to TD is designed to be large, which makes it difficult to miniaturize the optical system, and since the distance between the eleventh lens and the image sensor increases, the amount of unnecessary light may increase through the eleventh lens and the image sensor, and as a result, there is problem in that resolving power is lowed, such as deterioration in aberration characteristics.

$$0 < EPD / Imgh / FOV < 0.2 \qquad [ Equation 68 ]$$

In Equation 68, the relationship between the EPD, the length Imgh of ½ the maximum diagonal length of the image sensor, and the FOV may be established. Accordingly, the overall size and brightness of the optical system may be controlled. Equation 68 may preferably satisfy: 0<EPD/Imgh/FOV<0.1.

$$10 < FOV / F \# < 55 \qquad [ Equation 69 ]$$

Equation 69 may establish the relationship between the FOV of the optical system and the F number. Equation 69 may preferably satisfy: 30<FOV/F #<50.

$$0 < n 1 / n 2 < 1.5 \qquad [ Equation 70 ]$$

When the refractive indices n1 and n2 at the d-line of the first and second lenses 101 and 102 of Equation 70 satisfy the above range, the optical system may improve the resolution of incident light. Preferably, 0<n1/n2<1.2 may be satisfied.

$$( v 3 * n 3 ) < ( v 1 * n 1 ) \qquad [ Equation 71 ]$$

In Equation 71, when the refractive index n1 and Abbe number v1 of the first lens 101 and the refractive index n3 and Abbe number v3 of the third lens 103 are satisfied, the first and third lenses 101 and 103, the color dispersion of the transmitted light may be controlled.

$$( v 3 * n 3 ) < ( v 2 * n 2 ) \qquad [ Equation 72 ]$$

In Equation 72, when the refractive index n2 and Abbe number v2 of the second lens 102 and the refractive index n3 and Abbe number v3 of the third lens 103 are satisfied, the color dispersion of the light transmitted through the second and third lenses 102 and 103 may be controlled.

$$0 < Inf 111 / Inf 112 < 1 \qquad [ Equation 73 ]$$

In Equation 73, the distance Inf111 from the optical axis OA to the critical point P2 of the twenty-first surface S21 of the eleventh lens 111 and the distance Inf112 from the critical point P1 of the twenty-second surface S22 may be set, and when this is satisfied, the curvature aberration of the eleventh lens may be controlled. Equation 73 can satisfy: 0<Inf111/Inf112<0.5.

$$\vert Max\_Sag102 \vert \leq \vert Max\_Sag92 \vert < \vert Max\_Sag112 \vert \qquad [ Equation 74 ]$$

In Equation 74, |Max_Sag92| is the maximum Sag value of the sensor-side surface of the ninth lens 109, |Max_Sag102| is the maximum Sag value of the sensor-side surface of the tenth lens 110, and |Max_Sag112| is the maximum Sag value of the sensor-side surface of the eleventh lens 111. When Equation 74 is satisfied, the heights of the outer portions of the ninth, tenth, and eleventh lenses may be set, and the path of light traveling to the outer portions of the ninth to eleventh lenses may be guided.

$$0 < \vert Max\_Sag82 - Max\_Sag92 \vert < 0. 5 \qquad [ Equation 75 ]$$

In Equation 75, |Max_Sag82| represents the maximum Sag value of the sensor-side surface of the eighth lens 108. When Equation 75 is satisfied, the height difference between the outer portions of the eighth and ninth lenses may be set, and the path of light traveling to the outer portions of the eighth and ninth lenses may be guided.

$$10 < ( TTL / Imgh ) * \vert Max\_Sag112 \vert * n < 25 \qquad [ Equation 76 ]$$

Equation 76 may set the maximum height of the sensor-side surface of the last lens, TTL, and Imgh, and preferably satisfies: 15<(TTL/Imgh)*|Max_Sag112|*n<20.

$$20 < ( F / Imgh ) * \vert Max\_Sag112 \vert * n < 35 \qquad [ Equation 77 ]$$

Equation 77 may set the maximum height of the sensor-side surface of the last lens and F, Imgh, and preferably satisfies the following condition: 25<(F/Imgh)*|Max_Sag112|*n<30.

$$20 < ( TD\_LG2 / TD\_LG1 ) * n < 50 \qquad [ Equation 78 ]$$

Equation 77 may set the optical axis distance of the first and second lens groups and the total number of lenses, and preferably satisfies the following condition: 30<(TD_LG2/TD_LG1)*n<45.

$$5 < ( CT\_Max + CG\_Max ) * n < 30 \qquad [ Equation 79 ]$$

In Equation 79, the maximum thickness among the thicknesses of each lens, the maximum distance between adjacent lenses, and the total number of lenses may be set. Preferably, the following condition may satisfy: 15<(CT_Max+CG_Max)*n<25.

$$40 < ( FOV * TTL ) / n < 150 \qquad [ Equation 80 ]$$

Equation 80 may satisfy the following condition: 60<(FOV*TTL)/n<100, depending on the FOV and the number n of lenses.

$$FOV \leq ( TLL * n ) \qquad [ Equation 81 ]$$

Equation 81 may set the FOV, total length TTL, and number n of lenses, and preferably satisfies the following condition: FOV<(TTL*n).

$$10 \; 00 < CA\_Max * TD * n < 1500 \qquad [ Equation 82 ]$$

$$60 < \vert Max\_Sag \vert * TD * n < 90 \qquad [ Equation 83 ]$$

In Equation 83, Max_Sag is the maximum Sag value (absolute value) among the object-side surface and the sensor-side surface of each lens, and preferably satisfies the following condition: 60<|Max_Sag|*TD*n<80.

In equations 76 to 83, n is the total number of lenses, and depending on the total number of lenses, a relationship with the optical axis distance TD_LG1 of the first lens group LG1, the optical axis distance TD_LG2 of the second lens group LG2, the maximum center thickness CT_Max of the lenses, the maximum center distance CG_Max, FOV, TTL, the maximum Sag value of the sensor-side surface of the eighth lens 108 or the maximum Sag value in the entire lens Max_Sag, and the optical axis distance TD of the lenses, etc. may be set. Accordingly, it is possible to control the chromatic aberration, resolution, size, etc. of an optical system with 12 or less lenses.

$$[ Equation 84 ]$$

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + …$$

In Equation 84, Z is Sag and can mean the distance in the optical axis direction from any position on the aspherical surface to the vertex of the aspherical surface. The Y may refer to the distance from any position on the aspherical surface to the optical axis in a direction perpendicular to the optical axis. The c may refer to the curvature of the lens, and K may refer to the Conic constant. Additionally, A, B, C, D, E, and F may mean aspheric constants.

The optical system 1000 according to the embodiment may satisfy at least one or two of Equations 1 to 83. In this case, the optical system 1000 may have improved optical characteristics. In detail, when the optical system 1000 satisfies at least one or two of Equations 1 to 83, the optical system 1000 has improved resolution and may improve aberration and distortion characteristics. In addition, the optical system 1000 may secure a BFL for applying the large-size image sensor 300, and may minimize the distance between the last lens and the image sensor 300 and thus have good optical performance in the center and periphery portions of the FOV. In addition, when the optical system 1000 satisfies at least one of Equations 1 to 83, it may include a relatively large image sensor 300, have a relatively small TTL value, and may provide a slimmer and more compact optical system and a camera module having the same.

In the optical system 1000 according to an embodiment, the distance between the plurality of lenses 100 may have a value set according to the region.

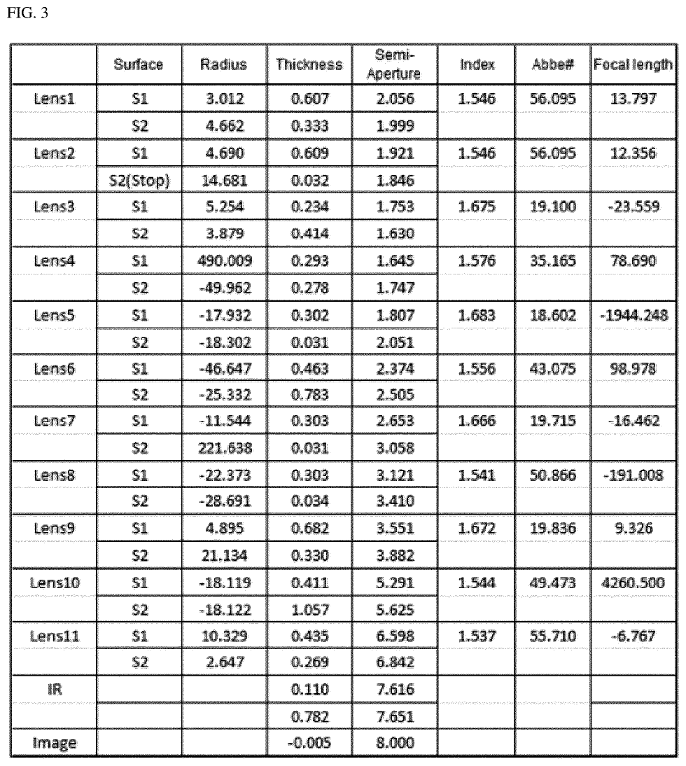

FIG. 3 is an example of lens data according to the first embodiment having the optical system of FIG. 1.

As shown in FIG. 3, the optical system according to the embodiment includes the curvature radius on the optical axis OA of the first to eleventh lenses 101-111, the thicknesses CT of the lenses, the distances CG between the lenses, refractive index at d-line (588 nm), Abbe Number, effective radius (Semi-Aperture), and focal length. In the absolute value of the focal length, the focal length of the tenth lens 110 is the maximum, and the focal length of the eleventh lens 111 is the minimum and may be smaller than the focal lengths of the first and second lenses.

Additionally, the number of lenses having a convex meniscus shape toward the object side may be 4 or more, and the number of lenses having a convex meniscus shape toward the sensor may be 4 or less. Additionally, at least one of the third and fourth lenses 103 and 104 may have the smallest effective radius (semi-aperture), for example, the fourth lens may have the smallest. Additionally, the eleventh lens 111 may have the largest effective radius, which is 11 mm or more. The curvature radius may be largest on the seventh side of the fourth lens.

The sum of the refractive indices of the plurality of lenses is 15 or more, the sum of the Abbe Numbers is 400 or more, for example, in the range of 400 to 450, and the sum of the center thicknesses of all lenses is 5 mm or less, for example, in the range of 4 mm to 5 mm. The sum of the center distance between the first to eleventh lenses in the optical axis may be 4 mm or less, for example, in the range of 3 mm to 4 mm, and the difference from the sum of the center thicknesses of the lenses may be more than 0.5 mm. Additionally, the average value of the effective diameter of each lens surface of the plurality of lenses is 8 mm or less, for example, in the range of 3 mm to 8 mm. The sum of the effective diameters of each lens surface of the plurality of lenses is the sum ΣCA of the effective diameters from the first surface S1 to the twenty-second surface S22, and may be 120 mm or more, for example, in the range of 120 mm to 150 mm. Additionally, the relationship between the total number (n) of lenses and the sum of the effective diameters may satisfy: ΣCA*n>1350.

As shown in FIG. 4, in the embodiment, at least one or all lens surfaces of the plurality of lenses may include an aspheric surface with a 30th order aspherical coefficient. For example, the first to eleventh lenses 101, 102, 103, 104, 105, 106, 107, 108, 109, and 111 may include lens surfaces having a 30th order aspheric coefficient from the first surface S1 to the twenty-second surface S22. As described above, an aspheric surface with a 30th order aspheric coefficient (a value other than “0”) may particularly significantly change the aspherical shape of the peripheral portion, so the optical performance of the periphery portion of the FOV may be well corrected.

As shown in FIG. 5, the first to eleventh thicknesses T1-T11 of the first to eleventh lenses 101-111 may be expressed at intervals of 0.1 mm or more in the direction Y from the center of each lens to the edge, the distances between adjacent lenses may be expressed as an interval of 0.1 mm or more from the first distance G1 to the tenth distance G10 in the direction from the center to the edge. The center distance of the ninth gap G9 may be the maximum, and the center thickness of the ninth lens 109 may be the maximum among the center thicknesses.

In the first thickness T1, the maximum thickness is located at the center and may be 1.1 times or more, for example, 1.1 to 3 times the minimum thickness. The maximum distance of the first distance G1 is located at the edge portion, and the difference from the minimum distance may be 1 time or more, for example, in the range of 1 to 3 times. The maximum thickness of the second thickness T2 is located at the center and may be 1.1 times or more, for example, in the range of 1.1 to 3 times the minimum thickness. The maximum distance of the second distance G2 is located at the edge and may be 3 times or more, for example, in the range of 3 to 8 times the minimum distance. In the third thickness T3, the maximum thickness is located at the edge and may be more than twice the minimum thickness, for example, in the range of 2 to 8 times. The maximum distance of the third interval G3 is located at the center, and the difference from the minimum distance may be 3 times or more, for example, in the range of 3 to 9 times. The maximum thickness of the fourth thickness T4 is located at the center and may be 3 times or less, for example, in the range of 1 to 3 times the minimum thickness. The maximum distance of the fourth distance G4 is located at the center and may be 5 times or less, for example, 1 to 5 times the minimum distance. In the fifth thickness T5, the maximum thickness is located at the edge and may be more than 1 time, for example, 1 to 3 times the minimum thickness. The maximum distance of the fifth distance G5 is located at the edge and may be 4 times or more, for example, 4 to 11 times the minimum distance.

The maximum thickness of the sixth thickness T6 is located at the center and may be at least 1 time the minimum thickness, for example, in the range of 1 to 5 times. The maximum distance of the sixth distance G6 is located at the center and may be at least 1 time the minimum distance, for example, in the range of 1 to 5 times. In the seventh thickness T7, the maximum thickness is located at the edge and may be 1 time or more, for example, in the range of 1 to 5 times the minimum thickness. The maximum distance of the seventh distance G7 is located in the region between the center and the edge and may be 5 times or less, for example, in the range of 1 to 5 times the minimum distance. The maximum thickness of the eighth thickness T8 is located at the edge and may be 1.1 times or more, for example, in the range of 1.1 to 3 times the minimum thickness. The maximum distance of the eighth distance G8 is located in the region between the center and the edge and may be 5 times or more, for example, in the range of 5 to 15 times the minimum distance. The maximum thickness of the ninth thickness T9 is located at the center and may be at least 1 time the minimum thickness, for example, in the range of 1 to 3 times. The maximum distance of the ninth distance G9 is located at the edge and may be 5 times or less, for example, in the range of 1.1 to 5 times the minimum distance. The maximum thickness of the tenth thickness T10 is located at the edge and may be 1.1 times or more, for example, in the range of 1.1 to 3 times the minimum thickness. The maximum distance of the tenth distance G10 is located in the region between the center and the edge and may be 3 times or more, for example, in the range of 3 to 8 times the minimum distance. The maximum thickness of the eleventh thickness T11 is located in the region between the center and the edge and may be 1.1 times or more, for example, in the range of 1.1 to 7 times the minimum thickness. The optical system uses the above-mentioned first to eleventh thicknesses T1-T11 and first to tenth intervals G1-G10 to provide a slim and compact size for a lens optical system with 12 or less lenses.

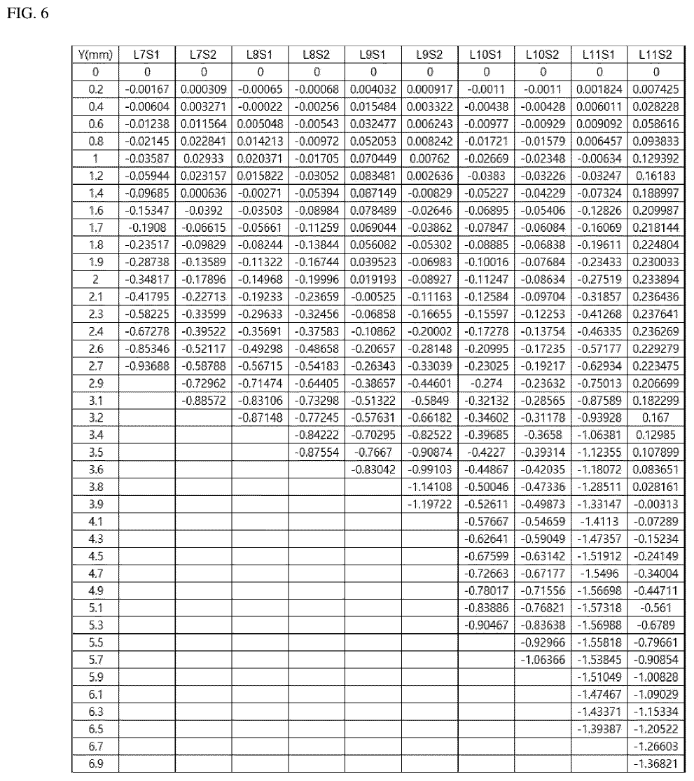

FIG. 6 shows each of the Sag values of the object-side surface L7S1 and the sensor-side surface L7S2 of the seventh lens 107, the Sag values of the object-side surface L8S1 and the sensor-side surface L8S2 of the eighth lens 108, the Sag values of object-side surface L9S1 and the sensor-side surface L9S2 of the ninth lens 109, the Sag values of the object-side surface L10S1 and the sensor-side surface L10S2 of the tenth lens 110, and the Sag values of the object-side surface L11S1 and the sensor-side surface L11S2 of the eleventh lens 111 according to an embodiment of the invention. The Sag value may be expressed as the height (Sag value) from the straight line in the direction X and Y perpendicular to the center of each lens surface to the lens surface at intervals of 0.1 mm or more.

Referring to FIG. 6, it may be seen that the Sag values all have negative (−) values at the edges of each lens surface, extending in the direction toward the object rather than the straight line. The Sag values have a height of more than 0.7 mm in absolute value, for example in the range of 0.8 mm to 1.5 mm. Based on the absolute value, the Sag value of L11S1 may be the highest and the Sag value of L9S1 may have the smallest value among the lens surfaces from the ninth lens to the eleventh lens. In addition, the Sag value of L11S1 and the Sag value (absolute value) of L11S2 have a value of 1.1 mm or more, are provided larger than the Sag values of other lens surfaces, and light incident through the outer portion of the seventh to tenth lenses may be refracted to the image sensor.

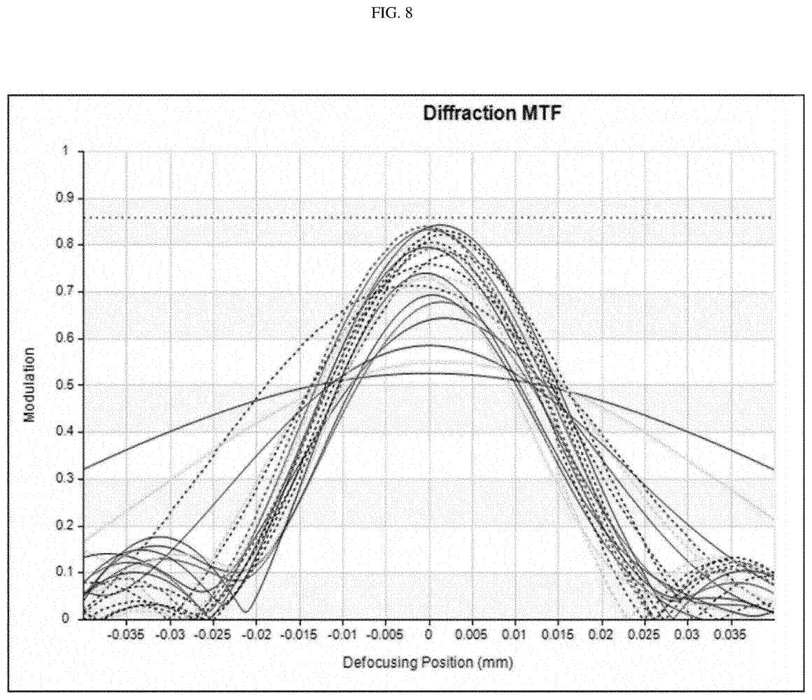

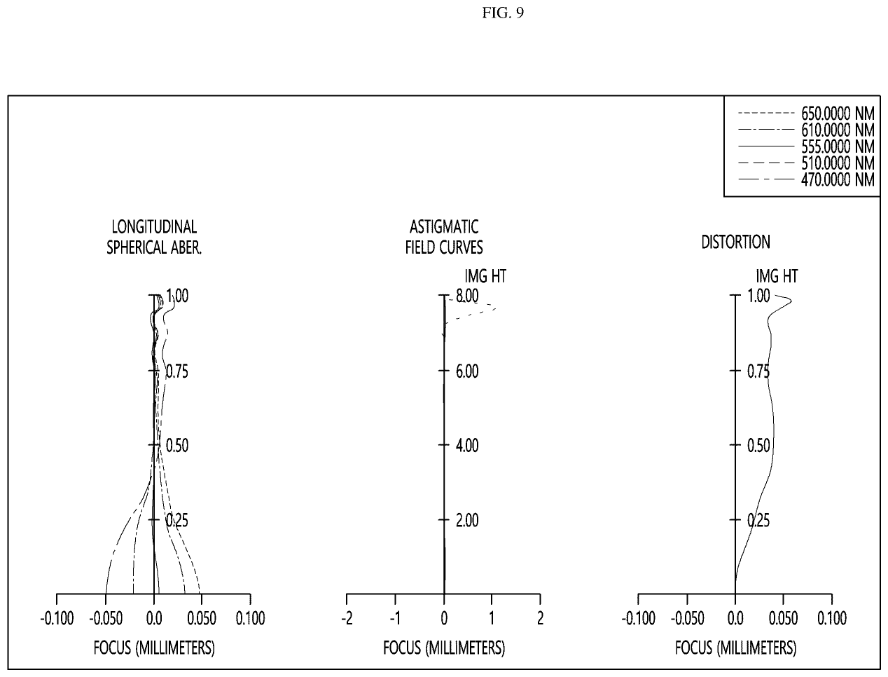

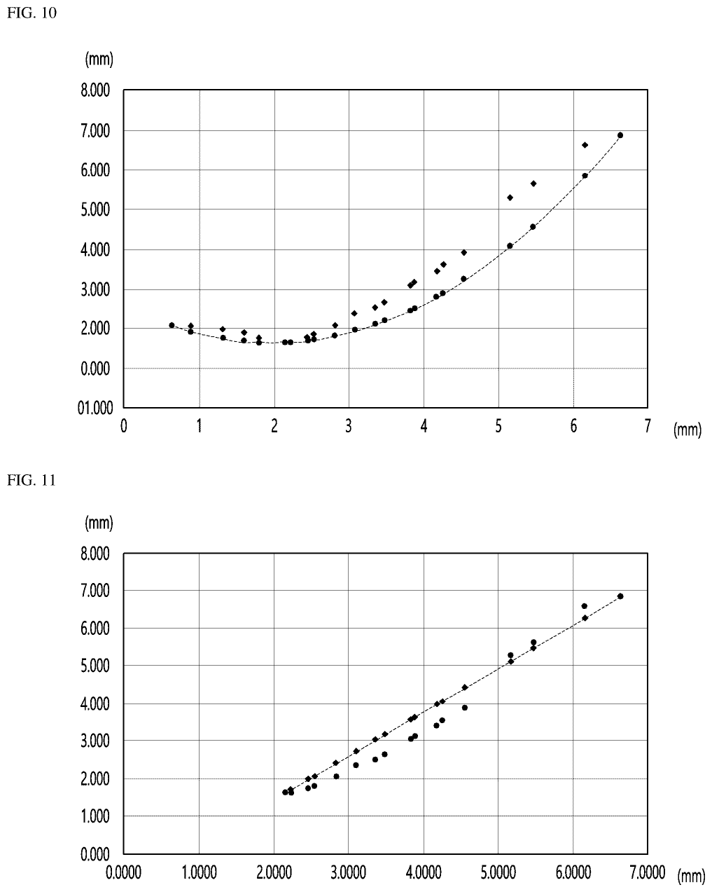

FIG. 12 is a graph showing the Sag values of the object-side surfaces and the sensor-side surfaces of the tenth and eleventh lenses shown in FIG. 6. As shown in FUGS. 6 and 12, the object-side surface L11S1 of the eleventh lens may have a critical point at a position between 1 mm from the optical axis, and the sensor-side surface of the eleventh lens may have a critical point of 1.5 mm or more, for example, in a range of 1.5 mm to 2.6 mm. Accordingly, the optical system 1000 according to the embodiment may have good optical performance in the center and peripheral portions of the FOV and may have excellent optical characteristics as shown in FIGS. 8 and 9.

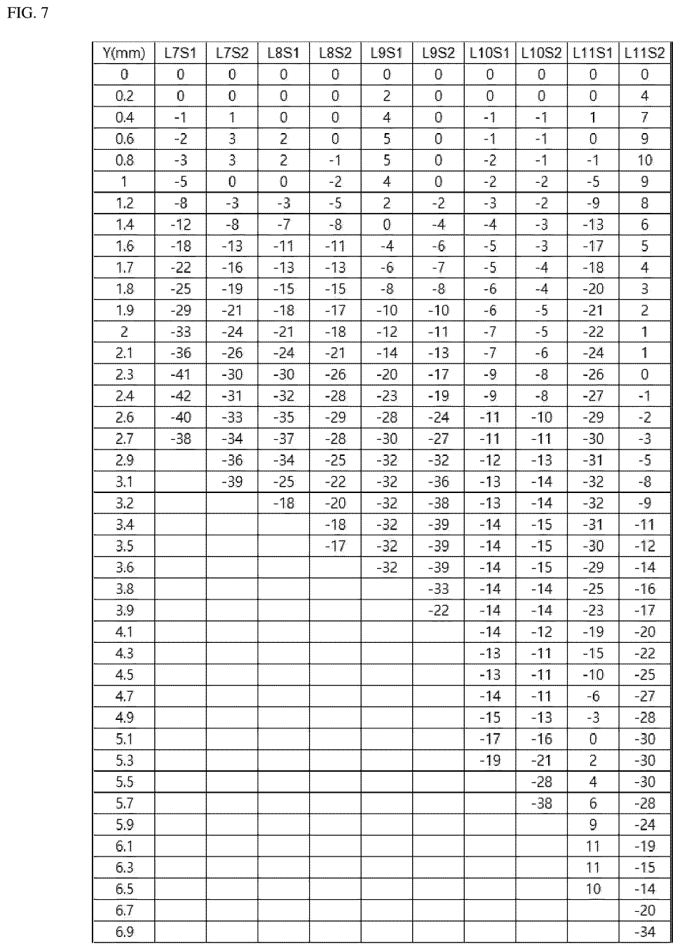

FIG. 7 is a table showing the inclination angles of the lens surfaces of the eleventh lens of the seventh range according to an embodiment of the invention. It Inclination angles of the object-side surface L7S1 and the sensor-side surface L7S2 of the seventh lens 107, inclination angles of the object-side surface L8S1 and the sensor-side surface L8S2 of the eighth lens 108, inclination angles of the object-side surface L9S1 and the sensor-side surface L9S2 of the lens 109, the inclination angle of the object-side surface L10S1 and the sensor-side surface L10S2 of the tenth lens 110, and inclination angles of the object-side surface L11S1 and the sensor-side surface L11S2 of the lens 111 are shown, respectively, and the inclination angle is the angle between the optical axis and the normal line perpendicular to the tangent line passing through the lens surface at intervals of 0.1 mm or more from the straight line in the directions X and Y perpendicular to the center of each lens surface. Here, the inclination angle is the angle between the optical axis and a normal line perpendicular to a tangent line passing through an arbitrary point of each lens surface.

In the lens surfaces of the seventh to eleventh lenses, a section in which the inclination angle has a value (absolute value) of 10 degrees or less with respect to the optical axis may be a position of 45% of the effective radius from the optical axis with respect to the lens surface with the minimum effective radius, such as in a range of 45% to 50%, or 1 mm or more, such as in the range of 1 mm to 1.5 mm. Here, among the lens surfaces of the seventh to eleventh lenses, the lens surface having the minimum effective radius may be the thirteenth surface of the seventh lens.

A section having an inclination angle (absolute value) of 10 degrees or less with respect to the optical axis on the sensor-side surface L11S2 of the eleventh lens 111 may be from the optical axis to a position greater than 45% of the effective radius, such as in the range 45% to 50%, or to a position greater than 3 mm, such as in the range 3 mm to 3.5 mm.

A section with an inclination angle of 10 degrees or less with respect to the optical axis on the object-side surface L10S1 and the sensor-side surface L10S2 of the tenth lens 110 may be from the optical axis to a position of 43% or more of the effective radius of the tenth lens 110, for example, in the range of 43% to 48%, or may be 2 mm or more, for example, in the range of 2 mm to 2.8 mm. These tenth and eleventh lenses may lower the inclination angle of the region overlapping with the seventh to ninth lenses to 10 degrees or less by up to 43% or more, and may provide a slim optical system by reducing TTL.

FIG. 8 is a graph of the diffraction MTF characteristics of the optical system 1000 of FIG. 1, and FIG. 9 is a graph of the aberration characteristics of the optical system of FIG. 1.

In the aberration graph in FIG. 8, spherical aberration, astigmatic field curves, and distortion are measured from left to right. In FIG. 9, the X-axis may mean a focal length (mm) and distortion (%), and the Y-axis may mean the height of an image. In addition, a graph of spherical aberration is a graph of light in a wavelength band of about 470 nm, about 510 nm, about 555 nm, about 610 nm, and about 650 nm, and a graph of astigmatism and distortion is a graph of light in a wavelength band of 555 nm. In the aberration diagrams of FIG. 9, it may be interpreted that the aberration correction function is better as each curve approaches the Y-axis. Referring to FIG. 9, in the optical system 1000 according to the embodiments, it may be seen that measurement values are adjacent to the Y-axis in almost all regions. That is, the optical system 1000 according to the embodiment has improved resolution and may have good optical performance not only in the center portion but also in the periphery portion of the FOV. As confirmed in the above examples, the optical system according to the invention is compact and lightweight with a lens configuration of 10 or more, for example, 12 or less, and at the same time, spherical aberration, astigmatism, distortion aberration, chromatic aberration and coma are all well corrected to provide high resolution. Since it is possible to implement, it may be used by being built into the optical device of the camera.

Table 1 shows the items of the above-described equations in the optical system 1000 according to the first and second embodiments, and relates TTL, BFL, and total effective focus length F of the optical system 1000, Imgh, focal length F1-F11 of each of the first to eleventh lenses, edge thickness, edge distance, composite focal length, distances Inf111 and Inf112 to the critical points, etc.

TABLE 1

| Items | Embodiment | Items | Embodiment |
|---|---|---|---|
| F | 7.846 | ET1 | 0.256 |
| F1 | 13.797 | ET2 | 0.276 |
| F2 | 12.356 | ET3 | 0.338 |
| F3 | −23.559 | ET4 | 0.252 |
| F4 | 78.690 | ET5 | 0.296 |
| F5 | −1944.248 | ET6 | 0.255 |
| F6 | 98.978 | ET7 | 0.350 |
| F7 | −16.462 | ET8 | 0.298 |
| F8 | −191.008 | ET9 | 0.292 |
| F9 | 9.326 | ET10 | 0.305 |
| F10 | 4260.500 | ET11 | 0.481 |
| F11 | −6.767 | EG1 | 0.429 |
| F13 | 8.689 | EG2 | 0.217 |
| F411 | −16.624 | EG3 | 0.063 |
| Inf111 | 0.6 | EG4 | 0.059 |
| Inf112 | 2.2 | EG5 | 0.278 |
| FOV | 90.000 | EG6 | 0.122 |
| EPD | 4.047 | EG7 | 0.042 |
| BFL | 1.156 | EG8 | 0.080 |
| TD | 7.964 | EG9 | 0.618 |
| Imgh | 8.000 | EG10 | 0.688 |
| SD | 6.416 | ΣIndex | 17.542 |
| F# | 1.939 | ΣAbbe | 423.732 |
| TTL | 9.120 | ΣCT | 4.642 |
| ΣCA | 134.730 | ΣCG | 3.322 |

Table 2 shows the result values for Equations 1 to 40 described above in the optical system 1000 of FIG. 1. Referring to Table 2, it may be seen that the optical system 1000 satisfies at least one, two, or three of Equations 1 to 40. In detail, it may be seen that the optical system 1000 according to the embodiment satisfies all of Equations 1 to 40 above. Accordingly, the optical system 1000 may improve optical performance and optical characteristics in the center and periphery portions of the FOV.

TABLE 2

| | |
|---|---|
| Equations | Embodiment |

| | | |
|---|---|---|
| 1 | 1 < CT1/CT3 < 6 | 2.599 |
| 2 | 0 < CT3/ET3 < 2 | 0.691 |
| 3 | 18 < TTL/CT_Aver < 28 | 21.612 |
| 4 | 1.60 < n3 | 1.675 |
| 5 | 0.5 < Max_Sag112 to Sensor < 1.5 | 0.918 |
| 6 | 0.8 < BFL/Max_Sag112 to Sensor < 2 | 1.259 |
| 7 | 5 < \|Max slope112\| < 65 | 34.000 |
| 8 | CT9 < \|Max_Sag112\| | Satisfaction |
| 9 | CG6 < \|Max_Sag102\| < (CG6*2) | Satisfaction |
| 10 | 1 < CG10/EG10 < 10 | 1.538 |
| 11 | 0 < CG10/CG6 < 3 | 1.351 |
| 12 | 0 < CT1/CT11 < 3 | 1.396 |
| 13 | 0 < CT10/CT11 < 2 | 0.945 |
| 14 | 0 < \|L10R2/L11R1\| < 20 | 1.755 |
| 15 | 0 < (CG10 − EG10)/CG10 < 1 | 0.350 |
| 16 | 0 < CA11/CA22 < 2 | 1.114 |
| 17 | 1 < CA112/CA31 < 6 | 3.903 |
| 18 | 0.5 < CA22/CA31 < 1.5 | 1.053 |
| 19 | 0.1 < CA52/CA102 < 1 | 0.365 |
| 20 | 1 < CA112/CA11 < 5 | 3.328 |
| 21 | 0 < CG3/EG3 < 10 | 6.569 |
| 22 | 0 < CG9/EG9 < 1 | 0.534 |
| 23 | 0 < G10_Max/CG10 < 2 | 1.021 |
| 24 | 0 < CT9/CG10 < 1 | 0.645 |
| 25 | 1 < CG10/CT10 < 5 | 2.571 |
| 26 | 1 < CG10/CT11 < 4 | 2.431 |
| 27 | 1 < \|L5R2/CT5\| < 100 | 60.651 |
| 28 | 0 < \|L5R1/L11R1\| < 10 | 1.736 |
| 29 | 0 < L1R1/L1R2 < 1 | 0.646 |
| 30 | 0 < L2R2/L2R1 < 1 | 0.319 |
| 31 | 0 < CT_Max/CG_Max < 2 | 0.645 |
| 32 | 1 < ΣCT/ΣCG < 2.5 | 1.397 |
| 33 | 10 < ΣIndex < 20 | 17.542 |
| 34 | 10 < ΣAbb/ΣIndex < 50 | 24.156 |
| 35 | 0 < \|Max_distoriton\| < 5 | 2.000 |
| 36 | 0 < EG_Max/CT_Max < 3 | 1.008 |
| 37 | 0.5 < CA11/CA_Min < 2 | 1.261 |
| 38 | 1 < CA_Max/CA_Min < 7 | 4.197 |
| 39 | 1 < CA_Max/CA_Aver < 4 | 2.234 |
| 40 | 0.1 < CA_Min/CA_Aver < 1 | 0.532 |

Table 3 shows the result values for Equations 41 to 83 described above in the optical system 1000 of FIG. 1. Referring to Table 3, the optical system 1000 may satisfy at least one or two of Equations 1 to 40 and at least one, two, or three of Equations 41 to 83. In detail, it may be seen that the optical system 1000 according to the embodiment satisfies all of Equations 1 to 83 above. Accordingly, the optical system 1000 may improve optical performance and optical characteristics in the center and periphery portions of the FOV.

TABLE 3

| Equations | | Embodiment |
|---|---|---|
| 41 | 0.1 < CA_Max/(2*Imgh) < 1.5 | 0.855 |
| 42 | 0.1 < TD/CA_Max < 1.5 | 0.582 |
| 43 | 0 < F/L11R2 < 5 | 2.964 |
| 44 | 1 < F/L1R1 < 10 | 2.605 |
| 45 | 0 < EPD/L11R2 < 5 | 1.529 |
| 46 | 0.5 < EPD/L1R1 < 8 | 1.343 |
| 47 | 0 < \|F1/F2\| < 2 | 1.117 |
| 48 | 0 < F13/F < 5 | 1.107 |
| 49 | 0 < \|F411/F13\| < 4 | 1.913 |
| 50 | 0 < F1/F < 3 | 1.758 |
| 51 | 1 < F4/F13 < 20 | 9.056 |
| 52 | 0 < \|F1/F411\| < 2 | 0.830 |
| 53 | 0 < F1/F4 < 1 | 0.175 |
| 54 | 2 < TTL < 20 | 9.120 |
| 55 | 2 < Imgh | 8.000 |
| 56 | BFL < 2.5 | 1.156 |
| 57 | 2 < F < 20 | 7.846 |
| 58 | FOV < 120 | 90.000 |
| 59 | 0.1 < TTL/CA_Max < 2 | 0.667 |
| 60 | 0.5 < TTL/Imgh < 3 | 1.140 |
| 61 | 0.01 < BFL/Imgh < 0.5 | 0.144 |
| 62 | 4 < TTL/BFL < 10 | 7.892 |
| 63 | 0.5 < F/TTL < 1.5 | 0.860 |
| 64 | 3 < F/BFL < 10 | 6.789 |
| 65 | 0 < F/Imgh < 3 | 0.981 |
| 66 | 1 < F/EPD < 5 | 1.939 |
| 67 | 0 < BFL/TD < 0.5 | 0.145 |
| 68 | 0 < EPD/Imgh/FOV < 0.2 | 0.006 |
| 69 | 10 < FOV/F# < 55 | 46.419 |
| 70 | 0 < n1/n2 < 1.5 | 1.000 |
| 71 | (v3*n3) < (v2*n2) | 1.063 |
| 72 | (v3*n3) < (v1*n1) | Satisfaction |
| 73 | 0 < Inf111/Inf112 < 1 | 0.273 |
| 74 | \|Max_Sag102\| ≤ \|Max_Sag92\| < \|Max_Sag112\| | Satisfaction |
| 75 | 0 < \|Max_Sag82 − Max_Sag92\| < 0.5 | Satisfaction |
| 76 | 10 < (TTL/Imgh)*\|Max_Sag112\|*n < 25 | 17.157 |
| 77 | 20 < (F/Imgh)*\|Max_Sag112\|*n < 35 | 26.876 |
| 78 | 20 < (TD_LG2/TD_LG1)*n < 50 | 38.711 |
| 79 | 10 < (CT_Max + CG_Max)*n < 30 | 19.134 |
| 80 | 40 < (FOV*TTL)/n < 150 | 74.618 |
| 81 | FOV ≤ (TTL*n) | Satisfaction |
| 82 | 1000 < CA_Max*TD*n < 1500 | 1198.764 |
| 83 | 60 < \|Max_Sag\|*TD*n < 90 | 70.028 |

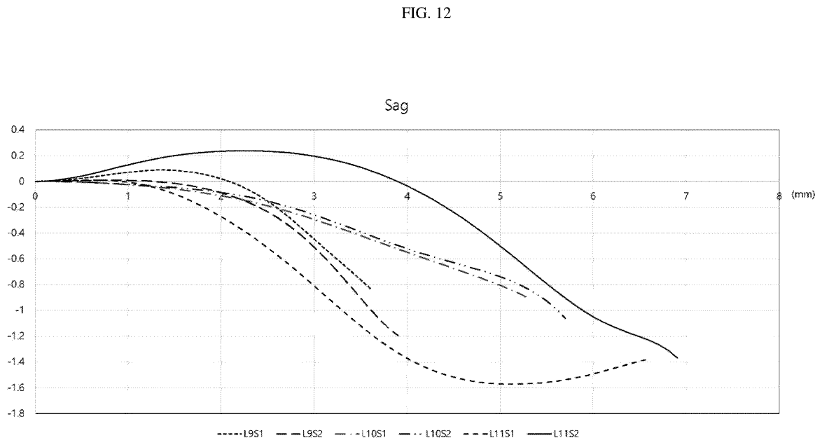

FIG. 11 is a graph showing a quadratic function of a curve connecting points passing through the ends of the effective regions of lenses according to an embodiment of the invention. That is, data from the end of the effective region of the object-side surface of the first lens to the end of the effective region of the sensor-side surface of the eleventh lens may be expressed by approximating a quadratic function.

The quadratic function may be expressed as Function 1 for the embodiment and may have the following relationship.

$$y = 0.2411 {x}^{2} - 0.9546 x + z \qquad [ Function 1 ]$$

In function 1, z is a coefficient that sets the position in the y-axis direction and may be set to 2.5±0.2. Additionally, in function 1, the fitting coefficient R2, which may be expressed by approximating the lens data as a function, is 0.90, and the closer it is to 1, the closer it may be to the function. This function 1 may satisfy the condition: y=A x²−B x+Z, where A may be in a range of 0.20˜0.30, B may be in a range of 0.5˜1.2, and z may be in a range of 2.3˜2.7.

FIG. 12 is a graph showing a straight line connecting points passing through the end of the effective region from the sensor-side surface of the third lens to the n-th lens according to an embodiment of the invention as a linear function. In other words, a linear function may be expressed by approximating the data from the minimum effective diameter to the maximum effective diameter, and may have the following relationship.

$$y = 1.1638 x - z \qquad [ Function 2 ]$$

In function 2, z is a coefficient that sets the position in the y-axis direction and may be set to 0.8±0.2. Additionally, in function 2, the fitting coefficient R2, which may be expressed by approximating the lens data as a function, is 0.90 or more, and the closer it is to 1, the closer it may be to the function. This function 2 may satisfy the condition: y=C x−z, where C may be in the range of 1.1 to 1.2, and z may be in the range of 0.8 to 1.0. Here, the linear function may be inclined at least 30 degrees with respect to the optical axis, for example, in the range of 30 degrees to 52 degrees.

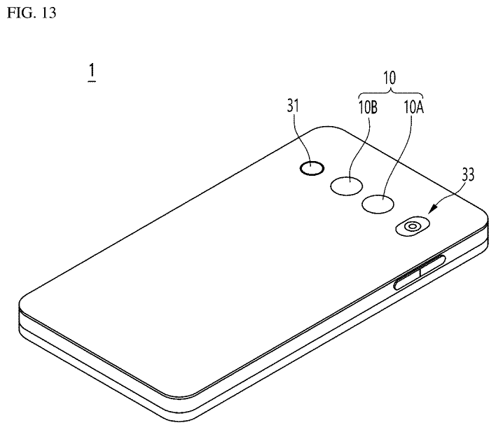

FIG. 13 is a diagram illustrating that a camera module according to an embodiment is applied to a mobile terminal.

Referring to FIG. 13, the mobile terminal 1 may include a camera module 10 provided on the rear side. The camera module 10 may include an image capturing function. In addition, the camera module 10 may include at least one of an auto focus function, a zoom function, and an OIS function.

The camera module 10 may process a still image or video frame obtained by the image sensor 300 in a shooting mode or a video call mode. The processed image frame may be displayed on a display unit (not shown) of the mobile terminal 1 and may be stored in a memory (not shown). In addition, although not shown in the drawings, the camera module may be further disposed on the front side of the mobile terminal 1.

For example, the camera module 10 may include a first camera module 10A and a second camera module 10B. At this time, at least one of the first camera module 10A and the second camera module 10B may include the above-described optical system 1000. Accordingly, the camera module 10 may have a slim structure and may have improved distortion and aberration characteristics. In addition, the camera module 10 may have good optical performance even in the center and periphery portions of the FOV.

In addition, the mobile terminal 1 may further include an auto focus device 31. The auto focus device 31 may include an auto focus function using a laser. The auto-focus device 31 may be mainly used in a condition in which an auto-focus function using an image of the camera module 10 is degraded, for example, a proximity of 10 m or less or a dark environment. The autofocus device 31 may include a light emitting unit including a vertical cavity surface emitting laser (VCSEL) semiconductor device and a light receiving unit such as a photodiode that converts light energy into electrical energy.

In addition, the mobile terminal 1 may further include a flash module 33. The flash module 33 may include a light emitting element emitting light therein. The flash module 33 may be operated by a camera operation of a mobile terminal or a user's control.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention.

In addition, although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1. An optical system comprising:
first to eleventh lenses arranged along an optical axis toward a sensor side from an object side,
wherein the first lens has positive refractive power on the optical axis and has a meniscus shape convex toward the object side,
wherein the eleventh lens has negative refractive power on the optical axis and has a concave sensor-side surface,
wherein the sensor-side surface of the eleventh lens has a critical point between the optical axis and an end of an effective region,
wherein an object-side surface and a sensor-side surface of the tenth lens are provided without a critical point from the optical axis to an end of an effective region, and
wherein the object-side surface and the sensor-side surface of the tenth lens have an inclination angle of less than 10 degrees from the optical axis to more than 43% of an effective radius of the tenth lens.

2. The optical system of claim 1,
wherein the sensor-side surface of the eleventh lens has an inclination angle of less than 10 degrees from the optical axis to more than 45% of an effective radius.

3. The optical system of claim 1,
wherein object-side and sensor-side surfaces of the seventh to ninth lenses have an inclination angle of 10 degrees or less from the optical axis to 45% or more of an effective radius of the object-side surface of the seventh lens.

4. The optical system of claim 4,
wherein the second lens has a meniscus shape convex toward the object side,
wherein the eleventh lens has a meniscus shape convex toward the object side.

5. The optical system of claim 1,
wherein a center distance between the tenth lens and the eleventh lens is a largest among center distances between adjacent lenses,
wherein a center thickness of the ninth lens is a largest among center thicknesses of the first to eleventh lenses.

6. The optical system of claim 1,
wherein a field of view of the optical system is FOV,
wherein an optical axis distance from a center of an object-side surface of the first lens to an upper surface of the image sensor is TTL,
wherein a total number of lenses is n, and
wherein the following Equation satisfies: FOV<(TTL*n).

7. The optical system of claim 1,
wherein an object-side surface of the ninth lens has a critical point,
wherein the critical point of the sensor-side surface of the eleventh lens is disposed closer to an edge than the critical point of the object-side surface of the ninth lens.

8. The optical system of claim 1,
wherein a refractive index n1 of the first lens satisfies the following condition: 16<n1*n<18,
wherein a refractive index n2 of the eleventh lens satisfies the following condition: 16<n11*n<18,
wherein a refractive index of the third lens is n3,
where n is a total number of lenses,
wherein the following Equation satisfies: 17<n3*n.

9. The optical system of claim 1,
wherein a number of lenses with a refractive index of less than 1.6 among the first to eleventh lenses is 6 or more,
wherein refractive indices of the first, second, and third lenses are n1, n2, and n3,
wherein Abbe numbers of the first, second, and third lenses are v1, v2, and v3,
wherein the following Equation satisfies: (v3*n3)<(v1*n1)
wherein the following Equation satisfies: (v3*n3)<(v2*n2).

10. The optical system of claim 1,
wherein a sum of effective diameters of object-side and sensor-side surfaces of the first to eleventh lenses is ΣCA,
wherein a total number of lenses is n,
wherein the following Equation satisfies: ΣCA*n>1350.

11. An optical system comprising:
a first lens having a meniscus shape convex toward an object side;
a second lens disposed on a sensor side of the first lens;
an n-th lens closest to an image sensor;
an n−1th lens disposed on an object side of the n-th lens; and
five or more lenses disposed between the second lens and the n−1th lens,
wherein one of lenses disposed between the second lens and the n−1th lens has a minimum effective diameter,
wherein the n-th lens has a maximum effective diameter among the lenses of the optical system,
wherein the n-th lens has a meniscus shape convex toward the object side,
wherein the n−1th lens has a meniscus shape convex toward the sensor side,
wherein a sensor surface of the n-th lens has a critical point between the optical axis and the end of an effective region,
wherein a sum of center thicknesses of the lenses is ΣCT,
wherein a sum of an optical axis distance between two adjacent lenses is ΣCG,
wherein a maximum center thickness of the lenses is CT_Max,
wherein a maximum of optical axis distances between the adjacent lenses is CG_Max,
wherein n is a total number of lenses in the optical system,
wherein the following Equation satisfies: 1<ΣCT/ΣCG<2.5
wherein the following Equation satisfies: 10<(CT_Max+CG_Max)*n<30.

12-13. (canceled)

14. The optical system of claim 11,
wherein an object-side surface and a sensor-side surface of the n−1th lens are provided without a critical point from the optical axis to an end of an effective region.

15. The optical system of claim 11,
wherein an optical axis distance between the n-th lens and the n−1th lens is CG10,
wherein a center thickness of the n-th lens is CT11,
wherein the following Equation satisfies: 2<CG10/CT11<3.

16. The optical system of claim 11,
wherein the sum of the center thicknesses from the first lens to the n-th lens is ΣCT,
wherein the sum of the center distance between two adjacent lenses is ΣCG,
wherein the total number of lenses is n,
wherein the following Equation satisfies: ΣCT*n>45
wherein the following Equation satisfies: ΣCG*n>30.

17. The optical system of claim 11,
wherein a largest effective diameter between an object-side surface and sensor-side surface of each lens is CA_Max,
wherein ½ of a maximum diagonal length of the image sensor is Imgh,
wherein the following Equation satisfies: 0.5<CA_Max/(2*Imgh)<1.

18. The optical system of claim 11,
wherein an optical axis distance from a center of an object-side surface of the first lens to an upper surface of the image sensor is TTL,
wherein ½ of a maximum diagonal length of the image sensor is Imgh,
wherein an effective focal length of the optical system is F,
wherein a maximum separation distance from a center of a sensor-side surface of the n-th lens to a lens surface in direction of the optical axis based on a straight line extending in a direction perpendicular to the optical axis is Max_Sag112,
wherein the total number of lenses is n,
wherein the following Equation satisfies: 10<(TTL/Imgh)*|Max_Sag112*n<25.

19. An optical system comprising:
a first lens group having a plurality of lenses;
a second lens group having more lenses than the first lens group; and
an aperture stop disposed between lenses of the first lens group,
wherein the first lens group has a concave sensor-side surface closest to the second lens group,
wherein the second lens group has a convex object-side surface closest to the first lens group,
wherein a maximum effective diameter among the lenses of the first and second lens groups is CA_Max,
wherein an optical axis distance from a center of an object-side surface of a first lens in the first lens group to a sensor-side surface of a last lens in the second lens group is TD,
wherein a total number of lenses is n, and
the following Equation satisfies: 1000<CA_Max*TD*n<1500.

20. The optical system of claim 19,
wherein the first lens group has a different number of lenses with positive refractive power and a number of lenses with negative refractive power,
wherein the second lens group has the same number of lenses with positive refractive power and lenses with negative refractive power,
wherein the first lens of the first lens group has positive refractive power, and
wherein the last lens of the second lens group has a sensor-side surface having a critical point and negative refractive power.

21. The optical system of claim 19,
wherein a sum of center thicknesses of the lenses of the first and second lens groups is ΣCT,
wherein a sum of optical axis distances between two adjacent lenses is ΣCG,
wherein the total number of lenses in the optical system is n,
wherein the following Equation satisfies: 11<(ΣCT/ΣCG)*n<19.8.

22. A camera module comprising:
an image sensor; and
an optical filter disposed between the image sensor and a last lens of an optical system,
wherein the optical system includes an optical system according to claim 1,
wherein a total focal length is F,
wherein a distance in the optical axis from a center of an object-side surface of a lens closest to an object to an upper surface of an image sensor is TTL,
wherein ½ of a maximum diagonal length of the image sensor is Imgh,
wherein the total number of lenses is n
wherein the following Equations satisfy: 0.5<F/TTL<1.5
$$0.5 < TTL / Imgh < 3$$
$$44 \leq Imgh * n \leq 110 .$$
